(19) United States
(12) Patent Application Publication
(10) Pub. No.: US 2017/0234126 A1
(43) Pub. Date: Aug. 17, 2017

(54) METHODS OF DETERMINING PROPERTIES OF SUBSURFACE FORMATIONS USING LOW SALINITY WATER INJECTION

(71) Applicant: Board of Regents, The University of Texas System, Austin, TX (US)

(72) Inventors: Emad Walid Al-Shalabi, Austin, TX (US); Kamy Sepehrnoori, Austin, TX (US); Mojdeh Delshad, Austin, TX (US)

(21) Appl. No.: 15/430,641

(22) Filed: Feb. 13, 2017

Related U.S. Application Data
(60) Provisional application No. 62/295,233, filed on Feb. 15, 2016.

(51) Int. Cl. E21B 49/00; E21B 41/00; G01V 99/00; E21B 43/20

(52) U.S. Cl. CPC E21B 49/008; E21B 43/20; E21B 41/0092; G01V 99/005

(57) ABSTRACT

Disclosed herein are systems and methods for determining properties of subsurface formations, such as for oilfield applications. The methods can comprise calculating a Gibbs free energy of the subsurface formation using a parameter of the subsurface formation. The methods can further comprise determining the property of the subsurface formation using the Gibbs free energy of the subsurface formation. The methods can, in some examples, further comprise selecting an enhanced oil recovery technique for the subsurface formation based on the calculated property of the subsurface formation. In some examples, the enhanced oil recovery technique can comprise low salinity water injection.

### CROSS-REFERENCE TO RELATED APPLICATIONS

This application claims the benefit of U.S. Provisional Application No. 62/295,233, filed Feb. 15, 2016, which is hereby incorporated herein by reference in its entirety.

### BACKGROUND

Enhanced Oil Recovery (EOR) refers to techniques for increasing the amount of unrefined petroleum, or crude oil that may be extracted from an oil reservoir (e.g., an oil field). The low salinity water injection (LSWI) technique is an enhanced oil recovery technique that can be used at both laboratory and field scales and that reduces residual oil saturation via a combination of intertwined mechanisms. LSWI can be effective in improving oil recovery from both carbonate formations and sandstone formations. The mechanism controlling incremental oil recovery by LSWI is still uncertain. Furthermore, there are few proposed models in the literature for low salinity water injection, especially for carbonate rocks. The systems and methods discussed herein address these and other needs.

### SUMMARY

Disclosed herein are systems and methods for determining properties of subsurface formations, such as for oilfield applications. In some examples, the subsurface formation can comprise a carbonate formation. In some examples, the subsurface formation can comprise a sandstone formation.

The methods can comprise calculating a Gibbs free energy of the subsurface formation using a parameter of the subsurface formation. In some examples, the methods can further comprise collecting the parameter of the subsurface formation. The parameter can, in some example, be obtained at in situ conditions of the subsurface formation.

In some examples, the parameter of the subsurface formation can include temperature, pressure, porosity, pore volume, dimension, bulk volume, cross sectional area, permeability, rock type, or combinations thereof.

The parameter can, in some examples, include the mole fraction of an aqueous species in an aqueous solution injected into the subsurface formation; a chemical potential of an aqueous species in an aqueous solution injected into the subsurface formation; the salinity of an aqueous solution injected into the subsurface formation; the volume of an aqueous solution injected into the subsurface formation; the ionic strength of an aqueous solution injected into the subsurface formation; an activity coefficient of an aqueous species in an aqueous solution injected into the subsurface formation; the concentration of an aqueous species in an aqueous solution injected into the subsurface formation; the water activity of an aqueous solution injected into the subsurface formation; or combinations thereof.

In certain examples, the parameter includes the ionic strength of an aqueous solution injected into the subsurface formation and the method further comprises calculating the activity coefficient of an aqueous species in the aqueous solution injected into the subsurface formation using the ionic strength of the aqueous solution injected into the subsurface formation. Calculating the activity coefficient of an aqueous species in the aqueous solution injected into the subsurface formation can comprise, for example, using the Davies equation, the extended Debye-Huckel equation, the WATEQ Debye-Huckel equation, the Setchenow equation, or combinations thereof.

In certain examples, the parameter of the subsurface formation can comprise the concentration of an aqueous species in an aqueous solution injected into the subsurface formation and the method further comprises calculating the water activity of the aqueous solution injected into the subsurface formation using the concentration of the aqueous species in the aqueous solution injected into the subsurface formation. Calculating the water activity of the aqueous solution injected into the subsurface formation can comprise, for example, using Raoult's law or an approximation or derivative thereof.

In some examples, the parameter of the subsurface formation can include the Corey water exponent, the relative water permeability, the water saturation, or combinations thereof.

The methods can further comprise determining the property of the subsurface formation using the Gibbs free energy of the subsurface formation. Examples of properties of the subsurface formation include, but are not limited to, oil recovery, relative oil permeability, residual oil saturation, wettability alteration, dissolution, fine migration, Corey oil exponent, or combinations thereof.

The property of the subsurface formation can, in certain example, be the oil recovery from the subsurface formation. In some examples, the parameter can comprise a parameter of an enhanced oil recovery technique, such that the method comprises modeling the effect of the enhanced oil recovery technique on the subsurface formation. The parameter of the enhanced oil recovery technique can, for example, be selected to maximize the oil recovery from the subsurface formation.

The methods can, in some examples, further comprise selecting an enhanced oil recovery technique for the subsurface formation based on the calculated property of the subsurface formation.

Also disclosed herein are methods for maximizing the oil recovery from a subsurface formation. The methods for maximizing the oil recovery from a subsurface formation can, for example, comprise: selecting a first set of parameters for an enhanced oil recovery technique; calculating a first oil recovery from the subsurface formation based on the first set of parameters using any of the methods described herein; selecting a second set of parameters for the enhanced oil recovery technique; calculating a second oil recovery from the subsurface formation based on the second set of parameters using any of the methods described herein; comparing the first oil recovery to the second oil recovery to determine the larger oil recovery, thereby determining the set of parameters for the enhanced oil recovery technique that maximizes the oil recovery from the subsurface formation; selecting the set of parameters for the enhanced oil recovery technique that maximizes the oil recovery for the subsurface formation; and applying the enhanced oil recovery technique to the subsurface formation using the selected set of parameters; thereby maximizing the oil recovery from the subsurface formation.

In some examples, the enhanced oil recovery technique can comprise low salinity water injection.

Also disclosed herein are methods for determining properties of subsurface formations wherein the methods can comprise: receiving, using a computing device, the parameter of a subsurface formation; storing, using the computing device, the parameter of the subsurface formation; calculating, using the computing device, the Gibbs free energy of the subsurface formation using the parameter of the subsurface formation; and determining, using the computing device, a property of the subsurface formation using the Gibbs free energy.

Also disclosed herein are computing devices comprising a processor and a memory operably coupled to the processor, the memory having further computer-executable instructions stored thereon that, when executed by the processor, cause the processor to: receive a parameter of a subsurface formation; store the parameter of the subsurface formation; calculate a Gibbs free energy of the subsurface formation using the parameter of the subsurface formation; determine a property of the subsurface formation using the Gibbs free energy; and output the Gibbs free energy of the subsurface formation, the property of the subsurface formation, or a combination thereof.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DESCRIPTION OF FIGURES

The accompanying drawings, which are incorporated in and constitute a part of this specification, illustrate embodiments and together with the description, serve to explain the principles of the methods and systems:

FIG. 1 is a schematic of an exemplary computing device.

FIG. 2 shows the simulation model used in different runs with heterogeneous permeability (First Coreflood).

FIG. 3 shows example activity coefficient models for the calcium ion.

FIG. 4 shows the residual oil saturation as a function of effective Gibbs fee energy.

FIG. 5 shows the oil endpoint relative permeability as a function of molar Gibbs free energy.

FIG. 6 shows the oil Corey's exponent as a function of effective molar Gibbs free energy.

FIG. 7 shows the cumulative oil recovery history matching for the first coreflood (Mechanistic LSWI Model).

FIG. 8 shows the cumulative oil recovery history matching for the second coreflood (Mechanistic LSWI Model).

FIG. 9 shows the pressure drop history matching for the first coreflood (Mechanistic LSWI Model).

FIG. 10 shows the pressure drop history matching for the second coreflood (Mechanistic LSWI Model).

FIG. 11 shows the effective ionic strength calculated for both first and second corefloods (Mechanistic LSWI Model).

FIG. 12 shows the effective Gibbs free energy calculated for both the first and second corefloods (Mechanistic LSWI Model).

FIG. 13 shows the relative permeability curves used for the first coreflood (Mechanistic LSWI Model).

FIG. 14 shows the relative permeability curves used for the second coreflood (Mechanistic LSWI Model).

FIG. 15 shows the history matched sodium concentration using the updated geochemical model in UTCHEM.

FIG. 16 shows the history matched magnesium concentration using the updated geochemical model in UTCHEM.

FIG. 17 shows the history matched calcium concentration using the updated geochemical model in UTCHEM.

FIG. 18 shows the history matched chloride concentration using the updated geochemical model in UTCHEM.

FIG. 19 shows the history matched sulfate concentration using the updated geochemical model in UTCHEM.

FIG. 20 shows the history matched pH number using the updated geochemical model in UTCHEM.

FIG. 21 shows the cumulative oil recovery history matching for the third coreflood (Mechanistic LSWI Model).

FIG. 22 shows the pressure drop prediction for the third coreflood (Mechanistic LSWI Model).

FIG. 23 shows the effective Gibbs free energy calculated for the third coreflood (Mechanistic LSWI Model).

FIG. 24 shows the cumulative oil recovery history matching for the fourth coreflood (Mechanistic LSWI Model).

FIG. 25 shows the pressure drop history matching for the fourth coreflood (Mechanistic LSWI Model).

FIG. 26 shows the effective Gibbs free energy calculated for the fourth coreflood (Mechanistic LSWI Model).

FIG. 27 is the radial simulation model used in different runs with homogeneous permeability.

FIG. 28 is the radial simulation model used in different runs with heterogeneous porosity.

FIG. 29 is the radial simulation model used in different runs with heterogeneous permeability.

FIG. 30 is the permeability map used for the heterogeneous Cartesian case with V_{DP}=0.4.

FIG. 31 is the permeability map used for the heterogeneous Cartesian case with V_{DP}=0.8.

FIG. 32 shows the injection and production histories of the designed LSWI-SWCTT.

FIG. 33 is the residual oil saturation map at 0 days for the homogeneous radial model.

FIG. 34 is the residual oil saturation map at 31 days for the homogeneous radial model (gridblock #16).

FIG. 35 shows the saturation profiles for the water and oil phases at 0 days calculated using the homogeneous radial model.

FIG. 36 shows the saturation profiles for the water and oil phases at 31 days calculated using the homogeneous radial model.

FIG. 37 shows the residual oil saturation profiles calculated at different times using the homogeneous radial model.

FIG. 38 shows the concentration history of the different tracers used in the two stage SWCTT according to the homogeneous radial model.

FIG. 39 shows the analytical approach analysis for the EtAc and EtOH tracers in the first stage of the SWCTT using the homogeneous radial model.

FIG. 40 shows the analytical approach analysis for the EtAc and EtOH tracers in the second stage of the SWCTT using the homogeneous radial model.

FIG. 41 shows the relative permeability curves for both seawater and LSWI cycles (homogeneous radial model).

FIG. 42 shows the fractional flow curves used for seawater and LSWI cycles (homogeneous radial model).

FIG. 43 shows the analytical approach analysis for the EtAc and EtOH tracers in the first stage of the SWCTT using the heterogeneous radial model.

FIG. 44 shows the analytical approach analysis for the EtAc and EtOH tracers in the second stage of the SWCTT using the heterogeneous radial model.

FIG. 45 shows a comparison of the oil saturation distribution at 31 days at the x-z plane across the center of the reservoir for V_{DP}=0.4.

FIG. 46 shows a comparison of the oil saturation distribution at 31 days at the x-z plane across the center of the reservoir for V_{DP}=0.8.

FIG. 47 shows a comparison of the oil saturation distribution at 31 days at the y-z plane across the center of the reservoir for V_{DP}=0.4.

FIG. 48 shows a comparison of the oil saturation distribution at 31 days at the y-z plane across the center of the reservoir for V_{DP}=0.8.

FIG. 49 shows the average residual oil saturation at the center of the reservoir vs. time using the numerical approach for the heterogeneous Cartesian examples.

FIG. 50 shows the analytical approach analysis for the EtAc and EtOH tracers in the second stage of the SWCTT for the heterogeneous Cartesian case with V_{DP}=0.4.

FIG. 51 shows the analytical approach analysis for the EtAc and EtOH tracers in the second stage of the SWCTT for the heterogeneous Cartesian case with V_{DP}=0.8.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

Disclosed herein are systems and methods for determining properties of subsurface formations, such as for oilfield applications. The systems and methods discussed herein can provide benefits to the upstream oil industry.

The subsurface formation can be any formation of interest. In some examples, the formation can be adjacent to a well (e.g., petroleum, natural gas, water, CO₂). The formation can be on- or off-shore. In some examples, the subsurface formation can comprise a carbonate formation. In some examples, the subsurface formation can comprise a sandstone formation.

The methods can comprise calculating a Gibbs free energy of the subsurface formation using a parameter of the subsurface formation. In some examples, the methods can further comprise collecting the parameter of the subsurface formation. The parameter can, in some example, be obtained at in situ conditions of the subsurface formation.

In some examples, the parameter of the subsurface formation can include temperature, pressure, porosity, pore volume, dimension, bulk volume, cross sectional area, permeability, rock type, or combinations thereof.

In some example, an aqueous solution can be injected into the subsurface formation. Examples of aqueous solutions can include, but are not limited to, solutions of surfactants and/or polymers injected into the subsurface formation for enhanced oil recovery, water, seawater, alkaline solutions, and combinations thereof. The aqueous solution can comprise, for example, an aqueous species. Examples of aqueous species include, but are not limited to, ions, salts, polymers, surfactants, alcohols, and combinations thereof.

The parameter can, in some examples, include the mole fraction of an aqueous species in an aqueous solution injected into the subsurface formation; a chemical potential of an aqueous species in an aqueous solution injected into the subsurface formation; the salinity of an aqueous solution injected into the subsurface formation; the volume of an aqueous solution injected into the subsurface formation; the ionic strength of an aqueous solution injected into the subsurface formation; an activity coefficient of an aqueous species in an aqueous solution injected into the subsurface formation; the concentration of an aqueous species in an aqueous solution injected into the subsurface formation; the water activity of an aqueous solution injected into the subsurface formation; or combinations thereof.

In certain examples, the parameter includes the ionic strength of an aqueous solution injected into the subsurface formation and the method further comprises calculating the activity coefficient of an aqueous species in the aqueous solution injected into the subsurface formation using the ionic strength of the aqueous solution injected into the subsurface formation. Calculating the activity coefficient of an aqueous species in the aqueous solution injected into the subsurface formation can comprise, for example, using the Davies equation, the extended Debye-Huckel equation, the WATEQ Debye-Huckel equation, the Setchenow equation, or combinations thereof.

In certain examples, the parameter of the subsurface formation can comprise the concentration of an aqueous species in an aqueous solution injected into the subsurface formation and the method further comprises calculating the water activity of the aqueous solution injected into the subsurface formation using the concentration of the aqueous species in the aqueous solution injected into the subsurface formation. Calculating the water activity of the aqueous solution injected into the subsurface formation can comprise, for example, using Raoult's law or an approximation or derivative thereof.

In some examples, the parameter of the subsurface formation can include the Corey water exponent, the relative water permeability, the water saturation, or combinations thereof.

The methods can further comprise determining the property of the subsurface formation using the Gibbs free energy of the subsurface formation. Examples of properties of the subsurface formation include, but are not limited to, oil recovery, relative oil permeability, residual oil saturation, wettability alteration, dissolution, fine migration, Corey oil exponent, or combinations thereof.

The property of the subsurface formation can, in certain example, be the oil recovery from the subsurface formation. In some examples, the parameter can comprise a parameter of an enhanced oil recovery technique, such that the method comprises modeling the effect of the enhanced oil recovery technique on the subsurface formation. The parameter of the enhanced oil recovery technique can, for example, be selected to maximize the oil recovery from the subsurface formation.

The methods can, in some examples, further comprise selecting an enhanced oil recovery technique for the subsurface formation based on the calculated property of the subsurface formation.

Also disclosed herein are methods for maximizing the oil recovery from a subsurface formation. The methods for maximizing the oil recovery from a subsurface formation can, for example, comprise: selecting a first set of parameters for an enhanced oil recovery technique; calculating a first oil recovery from the subsurface formation based on the first set of parameters using any of the methods described herein; selecting a second set of parameters for the enhanced oil recovery technique; calculating a second oil recovery from the subsurface formation based on the second set of parameters using any of the methods described herein; comparing the first oil recovery to the second oil recovery to determine the larger oil recovery, thereby determining the set of parameters for the enhanced oil recovery technique that maximizes the oil recovery from the subsurface formation; selecting the set of parameters for the enhanced oil recovery technique that maximizes the oil recovery for the subsurface formation; and applying the enhanced oil recovery technique to the subsurface formation using the selected set of parameters; thereby maximizing the oil recovery from the subsurface formation.

In some examples, the enhanced oil recovery technique can comprise low salinity water injection.

Also disclosed herein are methods for determining properties of subsurface formations wherein the methods can comprise: receiving, using a computing device, the parameter of a subsurface formation; storing, using the computing device, the parameter of the subsurface formation; calculating, using the computing device, the Gibbs free energy of the subsurface formation using the parameter of the subsurface formation; and determining, using the computing device, a property of the subsurface formation using the Gibbs free energy.

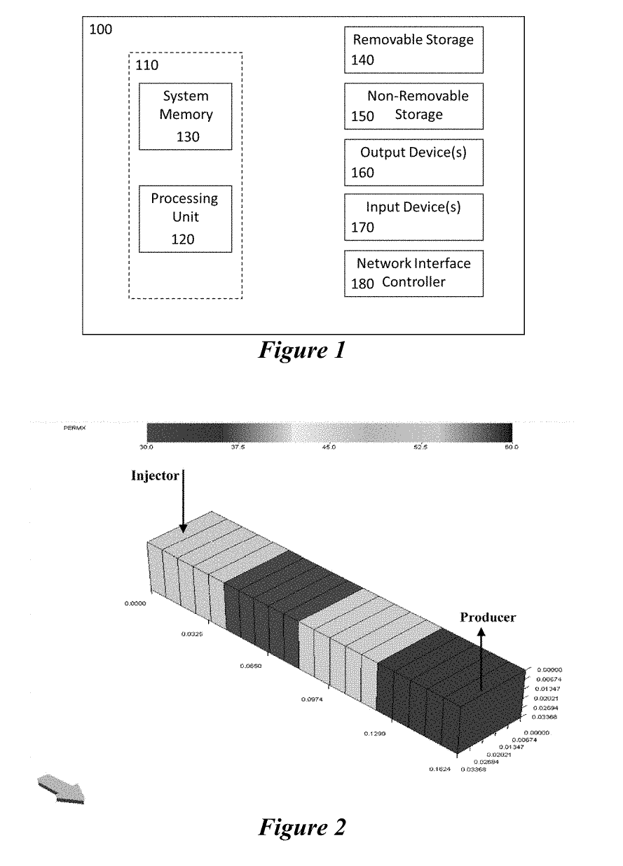

The methods disclosed herein can be carried out in whole or in part on one or more computing devices. For example, one or more of the calculating and determining steps can be carried out in whole or in part on one or more computing devices. FIG. 1 illustrates a suitable computing device upon which the methods disclosed herein may be implemented. The computing device 100 can include a bus or other communication mechanism for communicating information among various components of the computing device 100. In its most basic configuration, a computing device 100 typically includes at least one processing unit 120 (a processor) and system memory 130. As used herein, processor refers to a physical hardware device that executes encoded instructions for performing functions on inputs and creating outputs. Depending on the exact configuration and type of computing device 100, the system memory 130 may be volatile (such as random access memory (RAM)), non-volatile (such as read-only memory (ROM), flash memory, etc.), or some combination of the two. This most basic configuration is illustrated in FIG. 1 by a dashed line 110. The processing unit 120 may be a standard programmable processor that performs arithmetic and logic operations necessary for operation of the computing device 100.

The computing device 100 can have additional features/functionality. For example, the computing device 100 may include additional storage such as removable storage 140 and non-removable storage 150 including, but not limited to, magnetic or optical disks or tapes. The computing device 100 can also contain network connection(s) 180 that allow the device to communicate with other devices. The computing device 100 can also have input device(s) 170 such as a keyboard, mouse, touch screen, antenna or other systems configured to communicate with the camera in the system described above, etc. Output device(s) 160 such as a display, speakers, printer, etc. may also be included. The additional devices can be connected to the bus in order to facilitate communication of data among the components of the computing device 100.

The processing unit 120 can be configured to execute program code encoded in tangible, computer-readable media. Computer-readable media refers to any media that is capable of providing data that causes the computing device 100 (i.e., a machine) to operate in a particular fashion. Various computer-readable media can be utilized to provide instructions to the processing unit 120 for execution. Common forms of computer-readable media include, for example, magnetic media, optical media, physical media, memory chips or cartridges, a carrier wave, or any other medium from which a computer can read. Example computer-readable media can include, but is not limited to, volatile media, non-volatile media and transmission media. Volatile and non-volatile media can be implemented in any method or technology for storage of information such as computer readable instructions, data structures, program modules or other data and common forms are discussed in detail below. Transmission media can include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

For example, the processing unit 120 can execute program code stored in the system memory 130. For example, the bus can carry data to the system memory 130, from which the processing unit 120 receives and executes instructions. The data received by the system memory 130 can optionally be stored on the removable storage 140 or the non-removable storage 150 before or after execution by the processing unit 120.

The computing device 100 typically includes a variety of computer-readable media. Computer-readable media can be any available media that can be accessed by device 100 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 130, removable storage 140, and non-removable storage 150 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media can be part of computing device 100.

It should be understood that the various techniques described herein can be implemented in connection with hardware or software or, where appropriate, with combinations thereof. Thus, the methods, systems, and associated signal processing of the presently disclosed subject matter, or certain aspects or portions thereof, can take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs can implement or utilize the processes described in connection with the presently disclosed subject matter, e.g., through the use of an application programming interface, reusable controls, or the like. Such programs can be implemented in a high level procedural or object-oriented programming language to communicate with a computer system. However, the program(s) can be implemented in assembly or machine language, if desired. In any case, the language can be a compiled or interpreted language and it may be combined with hardware implementations.

Also disclosed herein are computing devices comprising a processor and a memory operably coupled to the processor, the memory having further computer-executable instructions stored thereon that, when executed by the processor, cause the processor to: receive a parameter of a subsurface formation; store the parameter of the subsurface formation; calculate a Gibbs free energy of the subsurface formation using the parameter of the subsurface formation; determine a property of the subsurface formation using the Gibbs free energy; and output the Gibbs free energy of the subsurface formation, the property of the subsurface formation, or a combination thereof.

Embodiments of the methods and systems may be described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process.

### Example 1

Low salinity water injection (LSWI) is an emerging approach to improve waterflood performance at low cost under certain conditions. The LSWI technique is effective in improving oil recovery from both carbonate formations and sandstone formations. The mechanism controlling incremental oil recovery by LSWI is still uncertain. Most of researchers believe wettability alteration is a contributor to the LSWI effect on oil recovery, especially for carbonates.

Laboratory work conducted on sandstones has shown a positive response on oil recovery (5-20% of original oil in place, OOIP) at both secondary and tertiary modes of injection of the LSWI method. The LSWI effect on oil recovery from sandstones can be due to one or more mechanisms, including: fines migration, pH increase, multi-ion exchange (MIE), salting-in, and wettability alteration (Doust A R et al. Energy & Fuels, 2009, 23(9), 4479-4485). Wettability alteration and enhancing oil recovery in sandstone rocks can be due to electrical double layer (EDL) expansion (Ligthelm D J et al. SPE 119835, 2009, EUROPEC/EAGE conference and Exhibition, Amsterdam, The Netherlands). Wettability alteration in sandstone rocks is related to the presence of clay minerals, oil composition, formation water with high concentrations of divalent cations (Ca²⁺, Mg²⁺), and the salinity level of the low salinity water (1000-5000 ppm) (Tang G Q and Morrow N R. SPE Reservoir Engineering, 1997, 12(4), 269-276, SPE 36680; Suijkerbuijk BMJM et al. SPE 169691, 2014, SPE EOR Conference at Oil and Gas West Asia, Muscat, Oman).

For carbonates, the effect of LSWI on oil recovery has not been thoroughly investigated, though wettability alteration is likely a contributor to LSWI effect on carbonate rocks. Wettability alteration on chalk can occur when the imbibing water has potentially determining ions including Ca²⁺, SO₄²⁻, and Mg²⁺ (Zhang P et al. Colloids and Surfaces A: Physicochemical and Engineering Aspects, 2007, 301(1-3), 199-128). The impact of different seawater dilutions on carbonate rocks to improve oil recovery showed incremental oil recovery up to 18% with stepwise dilution of sea water in the tertiary water injection mode (Yousef A A et al. SPE Reservoir Evaluation & Engineering Journal, SPE 137634, 2011, 14(5), 578-593; Yousef A A et al. SPE 154076, 2012, Eighteenth SPE Improved Oil Recovery Symposium, Tulsa, Okla., USA). The addition of ions to the seawater can further impact the oil recovery during LSWI, for example an incremental oil recovery of 15% and 20% OOIP when borate (BO₃³⁻) and phosphate (PO₄³⁻) ions were added to seawater, respectively (Gupta R et al. SPE 142668, 2011, SPE Middle East Oil and Gas Conference, Manama, Bahrain). In this such cases, the wettability alteration mechanism in carbonate rocks can be due to dissolution by low salinity brine and/or surface charge change by the injected ions (Gupta R et al. SPE 142668, 2011, SPE Middle East Oil and Gas Conference, Manama, Bahrain). An investigation of the brines that improve oil recovery and the associated mechanisms reported that seawater with only Ca²⁺ was unsuccessful in changing wettability state and both multi-ion exchange and mineral dissolution can be responsible for desorption of organic acid groups and hence wettability alteration (Chandrasekhar S and Mohanty K K. SPE 166280, 2013, ATCE, New Orleans, La.). An investigation of the impact of sulfate ions on oil recovery by smart waterflood from carbonates indicated using four times sulfate concentration as the optimum sulfate concentration (Awolayo A et al. SPE 169662, 2014, SPE EOR Conference at Oil and Gas West Asia, Muscat, Oman).

The field-scale studies of LSWI have mainly focused on sandstones, with a limited number of reports on LSWI application in carbonates being more recently available (Yousef A A et al. SPE 159526, 2012, SPE Annual Technical Conference and Exhibition, San Antonio, Tex.).

There are few proposed models in the literature for low salinity water injection, especially for carbonate rocks. One model for predictions of LSWI effect on oil recovery at the field considers salt as an additional single lumped component in the aqueous phase, and density and viscosity of the aqueous phase, relative permeability, and capillary pressure curves are all salinity dependent (Jerauld G R et al. SPE 102239, 2008, SPE Annual Technical Conference and Exhibition, San Antonio, Tex.). Another mathematical model for wettability alteration due to LSWI for porous and fractured media treats salt as an additional component in the aqueous phase, which is transported by advection and diffusion, including the adsorption effect on the surface of the rock (Wu Y and Bai B. SPE 118830, 2009, SPE Reservoir Simulation Symposium, The Woodlands, Tex.). Spontaneous imbibition experiments on a chalk (Stevns Klint Chalk core plugs) using LSWI were simulated using a 1D model Where the dynamic changes in both capillary pressure and relative permeability curves from oil-wet to water-wet were made dependent on salt concentration (Yu L et al. JPSE, 2009, 66(3-4), 171-179). Improving waterflood recovery using low salinity water injection was modeled using tracers that affect the rock and fluid properties in an unstructured grid simulator (Verma S et al. SPE 13920, 2009, International Petroleum Technology Conference, Doha, Qatar). A 1D mathematical model that coupled dissolution/precipitation and transport processes relevant to the chalk weakening effect in carbonate reservoirs has also been investigated (Evje S and Hiorth A. Networks and Heterogeneous Media, 2009, 5(2), 217-256). The effect of water chemistry on surface charge and rock dissolution in pure calcium carbonate rock was used to construct a chemical model that couples bulk aqueous and surface chemistry, thus addressing mineral precipitation and dissolution (Hiorth A et al. Transport in Porous Media, 2010, 85(1), 1-21). A low salinity water model that couples a comprehensive ion exchange model with geochemical processes to a multi-phase multi-component flow equation-of-state compositional simulator has also been examined (Dang CTQ et al. SPE 165903, 2013, SPE Asia Pacific Oil and Gas Conference and Exhibition, Jakarta, Indonesia).

It should be noted that the above described existing LSWI models treated water and oil phases similarly; P_{c} and kᵣ for both phases were shifted using a similar weighting factor. However, the oil relative permeability is more sensitive to LSWI than the water relative permeability is (Al-Shalabi E W et al. SPE 165974, 2013, SPE Reservoir Characterization and Simulation Conference and Exhibition, Abu Dhabi, UAE). Two models for predicting the effect of LSWI on oil recovery from carbonate rocks taking this into account are the Empirical and Fundamental LSWI Models (Al-Shalabi E W et al. SPE 169674, 2014, SPE EOR Conference at OGWA, Muscat, Sultanate of Oman; Al-Shalabi E W et al. SPE 169911, 2014, SPE Energy Resources Conference, Port of Spain, Trinidad and Tobago). The Empirical LSWI Model uses contact angle measurements and injected water salinity to shift oil relative permeability curves and adjust residual oil saturation while maintaining constant water relative permeability curves (Al-Shalabi E W et al. SPE 169674, 2014, SPE EOR Conference at OGWA, Muscat, Sultanate of Oman). The Fundamental LSWI Model captures the effect of LSWI through trapping number by modifying the capillary desaturation curve (Al-Shalabi E W et al. SPE 169911, 2014, SPE Energy Resources Conference, Port of Spain, Trinidad and Tobago).

Herein, a mechanistic geochemical model is discussed that investigates the effect of different geochemical reactions resulting from LSWI on oil recovery. The proposed Mechanistic LSWI Model was used to history match recently published corefloods using the UTCHEM mechanistic reservoir simulator. The UTCHEM simulator is a 3D multi-phase flow, transport, and chemical flooding simulator developed at The University of Texas at Austin (UTCHEM-9.0 Technical Documentation, 2000. The University of Texas at Austin, Volume II). Moreover, other sets of corefloods were chosen to validate the proposed LSWI mechanistic model. The geochemical model in the UTCHEM simulator was modified to calculate the molar Gibbs free energy of the brine. In the proposed LSWI mechanistic model, the relative permeability curves including the residual oil saturation are functions of the molar Gibbs free energy. Coreflood experiments were simulated and history matched using the proposed model. The proposed LSWI mechanistic model was further extended to include weakly-oil-wet to mixed-wet carbonate rocks. The mechanistic model captures the effects of both wettability alteration and/or dissolution/fine migration on oil recovery through changes in the molar Gibbs free energy. This model can be used for oil recovery predictions and optimization of LSWI field applications.

Herein, a first and second corefloods are history matched using the proposed mechanistic model which is implemented in the updated geochemical model of the UTCHEM simulator (Yousef A A et al. SPE Reservoir Evaluation & Engineering Journal, SPE 137634, 2011, 14(5), 578-593). The first and second corefloods were previously analyzed using the updated geochemical model in UTCHEM (Yousef A A et al. SPE Reservoir Evaluation & Engineering Journal, SPE 137634, 2011, 14(5), 578-593; Luo H et al. SPE 173211, 2015, SPE Reservoir Simulation Symposium, Houston, Tex., USA), which was validated against the PHREEQC simulator (Parkhurst D L and Appelo C A J. Description of Input and Examples for PHREEQC Version 3. Chapter 43 of Section A Groundwater, Book 6 Modeling Techniques, 2013). In this work, both the third coreflood (Yousef A A et al. SPE 154076, 2012, Eighteenth SPE Improved Oil Recovery Symposium, Tulsa, Okla., USA) and fourth coreflood (Chandrasekhar S and Mohanty K K. SPE 166280, 2013, ATCE, New Orleans, La.) are analyzed using the updated geochemical model in UTCHEM. Afterwards, the third and fourth corefloods are used to validate the proposed LSWI Mechanistic model.

Three horizontal corefloods were conducted by Yousef et al. (Yousef A A et al. SPE Reservoir Evaluation & Engineering Journal, SPE 137634, 2011, 14(5), 578-593; Yousef A A et al. SPE 154076, 2012, Eighteenth SPE Improved Oil Recovery Symposium, Tulsa, Okla., USA); the first and second corefloods in 2011 and the third coreflood in 2012. In each of these corefloods, the cores were saturated with live reservoir oil at the irreducible water saturation, and then field seawater was injected at the reservoir temperature and pressure, followed by the injection of different seawater dilutions in the tertiary mode. Moreover, Chandrasekhar and Mohanty (Chandrasekhar S and Mohanty K K. SPE 166280, 2013, ATCE, New Orleans, La.) conducted a vertical coreflood (Fourth Coreflood) at reservoir temperature and atmospheric pressure. The core was saturated with dead reservoir oil at the irreducible water saturation, and then different dilutions of field seawater were injected for the tertiary recovery. More details about the experimental work are described elsewhere (Yousef A A et al. SPE Reservoir Evaluation & Engineering Journal, SPE 137634, 2011, 14(5), 578-593; Yousef A A et al. SPE 154076, 2012, Eighteenth SPE Improved Oil Recovery Symposium, Tulsa, Okla., USA; Chandrasekhar S and Mohanty K K. SPE 166280, 2013, ATCE, New Orleans, La.). Herein, history matching of the LSWI cycles where wettability alteration and dissolution/fine migration can occur is described.

1D simulation models were developed for the first, second, and third corefloods (Yousef A A et al. SPE Reservoir Evaluation & Engineering Journal, SPE 137634, 2011, 14(5), 578-593; Yousef A A et al. SPE 154076, 2012, Eighteenth SPE Improved Oil Recovery Symposium, Tulsa, Okla., USA). Furthermore, a 2D simulation model (10×1×10) was developed for the fourth coreflood to capture the core heterogeneity upon which a Dykstra-Parson coefficient (V_{DP}) of 0.85 was assigned. Each of the first, second, and third corefloods was composed of a number of core plugs of slightly different permeability (Yousef A A et al. SPE Reservoir Evaluation & Engineering Journal, SPE 137634, 2011, 14(5), 578-593; Yousef A A et al. SPE 154076, 2012, Eighteenth SPE Improved Oil Recovery Symposium, Tulsa, Okla., USA). Hence, the simulation models used five gridblocks to represent each core plug and a permeability was assigned to each core plug. For example, the first coreflood has four core plugs, thus a total of 20 grid blocks were used in the simulation model (FIG. 2). Table 1 lists the properties of the four simulation models used.

TABLE 1
Summary of composite core models for corefloods.

| | First | Second | Third | Fourth |
|---|---|---|---|---|
| | Coreflood | Coreflood | Coreflood | Coreflood |
| Property | | | | |
| Porosity | 0.5210 | 0.2465 | 0.2130 | 0.2640 |
| Pore Volume (cc) | 45.87 | 66.53 | 87.12 | 15.80 |
| Diameter (cm) | 3.80 | 3.81 | 3.83 | 3.79 |
| Length (cm) | 16.24 | 23.65 | 35.81 | 5.30 |
| Bulk Volume (cc) | 184.180 | 269.632 | 412.564 | 59.792 |
| Cross Sectional | 11.341 | 11.401 | 11.521 | 11.282 |
| Area (cm²) | | | | |
| Number of Gridblocks | 20 × 1 × 1 | 30 × 1 × 1 | 25 × 1 × 1 | 10 × 1 × 10 |
| (Length × Width × | | | | |
| Height) | | | | |
| Gridblock Dimensions | | | | |
| Length (cm) | Variable | Variable | Variable | 0.3360 |
| Width (cm) | 3.3677 | 3.3765 | 3.3942 | 3.3590 |
| Height (cm) | 3.3677 | 3.3765 | 3.3942 | 0.5300 |

The geochemical model previously implemented in UTCHEM assumed that activity coefficients of all reactive species are unity and the activity of water is equal to unity (Bhuyan D. Development of an Alkaline/Surfactant/Polymer Compositional Reservoir Simulator. Petroleum & Geosystems Engineering, University of Texas at Austin, Ph.D. Dissertation, 1989). These are not good assumptions for modeling the reaction equilibria related to LSWI (Al-Shalabi E W et al. SPE 169101, 2014, SPE Improved Oil Recovery Symposium, Okla., USA). Hence, the current version of UTCHEM was modified by implementing different activity coefficient models and a water activity equation. The activity coefficient models describe the relation between the activity coefficients of the species and the ionic strength of the solution. The ionic strength of the solution (μ) is defined as follows:

μ=½Σᵢzᵢ²mᵢ (1)

where zᵢ is the valence number of the aqueous species i and mᵢ is the concentration of the aqueous species in molality (mole/kg water (mole/kgw)). Three activity coefficient models were implemented in UTCHEM; two for the charged aqueous species, including the Davies equation (Equation 2) and the extended or WATEQ Debye-Huckel equation (Equation 3); and one for the uncharged species, the Setchenow equation (Equation 4) (Sandler S I. Chemical, Biochemical, and Engineering Thermodynamics. Fourth Edition, 2006).

$$\begin{matrix}log {γ}_{i} = - {Az}_{i}^{2} ( \frac{\sqrt{μ}}{1 + \sqrt{μ}} - 0.3 μ ) & ( 2 ) \\ log {γ}_{i} = - \frac{{Az}_{i}^{2} \sqrt{μ}}{1 + {Ba}_{i}^{o} \sqrt{μ}} + {b}_{i} μ & ( 3 ) \\ log {γ}_{i} = {b}_{i} μ & ( 4 )\end{matrix}$$

In Equation 2 and Equation 3, A and B depend only on temperature. Equation 3 is the WATEQ Debye-Huckel equation where aᵢ^{o} and bᵢ are ion specific parameters fitted from mean-salt activity coefficient. When bᵢ is zero then Equation 3 becomes the Extended Debye-Huckel equation. In the Extended Debye-Huckel equation, aᵢ^{o} is the ion size parameter. Equation 3 becomes the Setchenow equation (Equation 4) when the first term of the activity coefficient equation is zero, and usually bᵢ is assumed to be 0.1 for all uncharged species (Parkhurst D L and Appelo C A J. Description of Input and Examples for PHREEQC Version 3. Chapter 43 of Section A Groundwater, Book 6 Modeling Techniques, 2013).

The equation implemented in UTCHEM for water activity is as follows:

α_{H}_{₂}_{O}=1−0.017Σᵢ₌₁^{N}^{_{aq}}mᵢ (5)

where i is a certain aqueous species, and N_{aq} is the total number of aqueous species. This equation is a previously reported approximation of Raoult's law (Ganels R M and Christ C L. Solutions, minerals, and equilibria. New York, Harper and Row, 1965).

For the mathematical statement of the reaction equilibrium, it is assumed that the reactive system compromises of J fluid species, K solid species, I matrix-adsorbed cations, and M micelle-associated cations, all made up of N elements. Hence, there are (J+K+I+M) unknown equilibrium concentrations and (J+K+I+M) independent equations are needed. These independent equations are given below.

Elemental mass balances give N equations of the form:

Cₙ^{T}=Σⱼ₌₁^{j}hₙⱼCⱼ+Σₖ₌₁^{K}gₙₖĈₖ+Σᵢ₌₁¹fₙᵢC̅ᵢ+Σₘ₌₁^{M}eₙₘC̅ₘ for n=1, . . . ,N (6)

Electrical neutrality in the bulk fluid phase provides one more equation:

Σⱼ₌₁^{j}zⱼCⱼ+Σₘ₌₁^{M}z̅ₘC̅ₘ=0 (7)

Equation 7 is not an independent equation because it is a linear combination of the set of mass balance equations; hence it can be used to replace of any one of the elemental material balance equations. The mass-action equations including aqueous reaction equilibria relations and solubility product constraints as discussed below.

Out of the J fluid chemical species, an arbitrary selection of N independent species can be made such that the concentration of the remaining (J-N) fluid species can be expressed in terms of the concentrations of these N independent species through aqueous reaction equilibrium relationships as follows in Equation 8.

Cᵣ=Kᵣ^{eq}πⱼ₌₁^{N}Cⱼ^{w}^{ᵣⱼ} for r=N+1, . . . ,J (8)

The solubility product constraint for each solid species is given by

Kₖ^{sp}≧πⱼ₌₁^{N}Cⱼ^{w}^{ₖⱼ} for k=1, . . . ,K (9)

where the solubility product constants Kₖ^{sp} are defined in terms of the independent chemical species concentrations. In case a solid is not present, the corresponding solubility product constraint is the inequality; otherwise, the equality constraint is used for the solid (Mohammadi H. Mechanistic Modeling, Design, and Optimization of Alkaline/Surfactant/Polymer Flooding. Petroleum & Geosystems Engineering, University of Texas at Austin, Ph.D. Dissertation, 2008).

There are other equilibrium reaction equations in the geochemical model in UTCHEM, including ion exchange equilibrium on matrix substrate, ion exchange equilibrium on micelles, and partitioning equilibrium of acid component between crude oil and water. Ion exchange equilibrium on matrix substrate can be important in the case of the presence of clay; ion-exchange equilibrium on micelles is used whenever surfactant is injected, and partitioning equilibrium of acid component between crude oil and water is used when there is in situ generation of surfactants.

Herein, the low salinity water injection (LSWI) technique is modeled mechanistically using an intensive physical thermodynamic property, namely the molar Gibbs free energy. The molar Gibbs free energy of a solution is defined as follows (Sandler S I. Chemical, Biochemical, and Engineering Thermodynamics. Fourth Edition, 2006):

G=Σᵢ₌₁^{N}^{_{aq}}x̅ᵢμᵢ (10)

where x̅ᵢ is the mole fraction of each aqueous species and μᵢ is the chemical potential of each species. The mole fraction and chemical potential of each species are expressed as:

$$\begin{matrix}{\overline{x}}_{i} = \frac{{x}_{i}}{{x}_{tot}} & ( 11 ) \\ {μ}_{i} = {G}_{i}^{o} + RT ln {a}_{i} & ( 12 )\end{matrix}$$

where xᵢ is the number of moles for the species i, xₜₒₜ is the total number of moles in the solution, Gᵢ^{o} is the standard Gibbs free energy, R is the universal gas constant, T is the temperature, and aᵢ is the activity of each species which is defined as follows:

αᵢ=γᵢCᵢ (13)

where γᵢ is the activity coefficient of species i and Cᵢ is the concentration of species i. An example of calculating the stoichiometric/total molar Gibbs free energy for the formation water used in the first and second corefloods is shown in Table 2 (Yousef A A et al. SPE Reservoir Evaluation & Engineering Journal, SPE 137634, 2011, 14(5), 578-593). The stoichiometric/total and effective calculations were carried out for both ionic strength and molar Gibbs free energy for different seawater dilution cycles used in the experiments, where an example for the first and second corefloods is listed in Table 3 (Yousef A A et al. SPE Reservoir Evaluation & Engineering Journal, SPE 137634, 2011, 14(5), 578-593).

TABLE 2
Example calculation of stoichiometric/total Gibbs free energy.

| | | | Mole | | Chemical | |
|---|---|---|---|---|---|---|
| Aqueous | Concentration | Weight | Fraction | Activity | Potential | |
| Species | (ppm) | Fraction | (x̅ᵢ) | (mole/kgw) | (μᵢ) (J/mole) | μᵢx̅ᵢ |
| Na | 59491 | 0.059 | 0.051 | 4.350 | 4560.94 | 233.52 |
| Ca | 19040 | 0.019 | 0.009 | 0.367 | −3111.46 | −29.25 |
| Mg | 2439 | 0.002 | 0.002 | 0.146 | −5968.01 | −11.85 |
| SO₄ | 350 | 0.000 | 0.000 | 0.000 | −26263.66 | −1.89 |
| Cl | 132060 | 0.132 | 0.074 | 2.446 | 2775.66 | 204.56 |
| CO₃ | 0 | 0.000 | 0.000 | 0.000 | 0.00 | 0.00 |
| HCO₃ | 354 | 0.000 | 0.000 | 0.004 | −17114.96 | −1.96 |
| H₂O | — | 0.786 | 0.864 | 0.851 | −501.05 | 432.68 |

| | |
|---|---|
| Gibbs Free Energy (J/mole) | −39.55 |

TABLE 3
Calculations of both total and effective ionic strength and Gibbs free
energy for seawater dilutions used in the first and second corefloods.

| | Ionic Strength | | Molar Gibbs | |
|---|---|---|---|---|
| | (mole/kgw) | | Free Energy (J/mole) | |
| | Stoichiometric/ | | Stoichiometric/ | |
| Water Type | Total | Effective | Total | Effective |
| Formation | 5.491 | 4.791 | −39.55 | −107.38 |
| Water | | | | |
| Seawater | 1.219 | 1.064 | −198.87 | −182.76 |
| 2x diluted | 0.591 | 0.538 | −133.95 | −130.07 |
| 10x diluted | 0.116 | 0.134 | −41.53 | −48.44 |
| 20x diluted | 0.058 | 0.083 | −23.93 | −31.89 |
| 100x diluted | 0.011 | 0.040 | −6.31 | −14.78 |

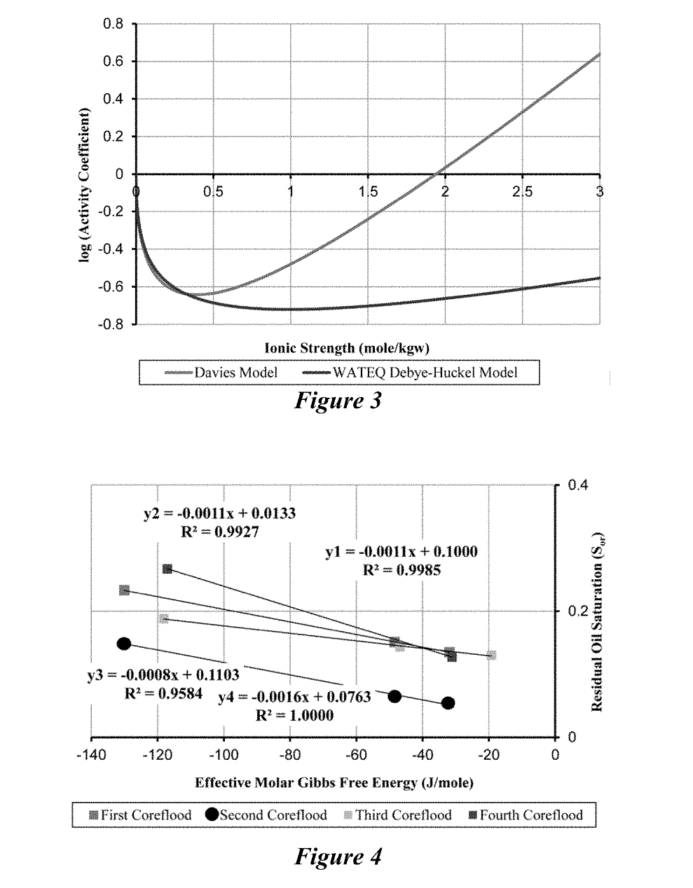

Table 3 shows that there is a pronounced difference between stoichiometric/total and effective ionic strength and molar Gibbs free energy. This difference can be due to the reactions between aqueous species and solid species in the case of in situ effective calculations. The latter can affect the effective molar Gibbs free energy through changing the ionic strength and hence the activity coefficients of different aqueous species. The increasing then decreasing trend of molar Gibbs free energy can be explained through the activity coefficient behavior for different species. When the salinity decreases, the ionic strength of the solution decreases, which leads to a change in the activity coefficients of different aqueous species. An example of the relation between the ionic strength and activity coefficient is shown in FIG. 3 for calcium species using two activity coefficient models: Davies and WATEQ Debye-Huckel.

FIG. 3 shows that as the ionic strength decreases from about 4-5 mole/kgw (formation water) to about 1-2 mole/kgw (seawater), the activity coefficient decreases and, hence, the molar Gibbs free energy decreases. For various dilutions of seawater, the ionic strength decreases below 0.5 mole/kgw whereas the activity coefficient of different aqueous species increases and approaches unity. Hence, the molar Gibbs free energy starts increasing, which is supported by Equations 12 and Equation 13 showing the relation between chemical potential and activity coefficient. As a result of this pronounced difference between stoichiometric/total and effective properties, the mechanistic model should be based on in situ effective conditions, which are more representative of realistic conditions.

The approach used to mechanistically model the LSWI technique takes into account the effects of wettability alteration and/or dissolution/fine migration on incremental oil recovery by LSWI. In this approach, residual oil saturation, the Corey oil exponent, and endpoint relative permeability are functions of the effective molar Gibbs free energy, while maintaining constant Corey water exponent and endpoint relative permeability.

The residual oil saturation (Sₒᵣ) is expressed as a function of effective molar Gibbs free energy as follows:

$$\begin{matrix}{S}_{or} ( Altered ) = ω \times {S}_{or}^{LS} + ( 1 - ω ) \times {S}_{or}^{HS} & ( 14 ) \\ ω = \frac{( \underline{G} - {\underline{G}}^{HS} )}{( {\underline{G}}^{LS} - {\underline{G}}^{HS} )} & ( 15 )\end{matrix}$$

where, Sₒᵣ^{HS} is the residual oil saturation at high injected water salinity (seawater), Sₒᵣ^{LS} is the residual oil saturation at low injected water salinity when Sₒᵣ stops changing, G is the effective rllolar Gibbs free energy (J/mole) at in situ conditions of the injected-connate mixed solution, G^{HS} is the effective molar Gibbs free energy (J/mole) at in situ conditions of the seawater-connate mixed solution, and G^{LS} is the effective molar Gibbs free energy (J/mole) at in situ conditions of the low salinity water-connate mixed solution when Sₒᵣ stops changing. The absolute error between the experimental and modeled residual oil saturation for both the first and second corefloods is presented in Table 4 (Yousef A A et al. SPE Reservoir Evaluation & Engineering Journal, SPE 137634, 2011, 14(5), 578-593).

Table 4 shows a negligible error difference between experimental and modeled residual saturations within 0.02 acceptable error difference. Moreover, a linear relation can be used in the model to express the residual oil saturation as a function of the effective molar Gibbs free energy for the four corefloods, as shown in FIG. 4.

TABLE 4
Absolute error between experimental and modeled residual
oil saturation using the Mechanistic LSWI Model.

| | Effective | | | | | | | |
|---|---|---|---|---|---|---|---|---|
| | Molar Gibbs | Experimental Sₒᵣ | | | Modeled Sₒᵣ | | Sₒᵣ Absolute Error | |
| Water | Free Energy | First | Second | | First | Second | First | Second |
| Type | (J/mole) | Coreflood | Coreflood | ωS | Coreflood | Coreflood | Coreflood | Coreflood |
| Seawater | −182.76 | 0.295 | 0.221 | — | — | — | — | — |
| 2x | −130.07 | 0.233 | 0.149 | 0.349 | 0.239 | 0.163 | 0.006 | 0.014 |
| Diluted | | | | | | | | |
| 10x | −48.44 | 0.151 | 0.064 | 0.890 | 0.153 | 0.072 | 0.002 | 0.008 |
| Diluted | | | | | | | | |
| 20x | −31.89 | 0.135 | 0.054 | 1 | 0.135 | 0.054 | 0.000 | 0.000 |
| Diluted | | | | | | | | |
| 100x | −14.78 | 0.135 | 0.054 | 1 | 0.135 | 0.054 | 0.000 | 0.000 |
| Diluted | | | | | | | | |

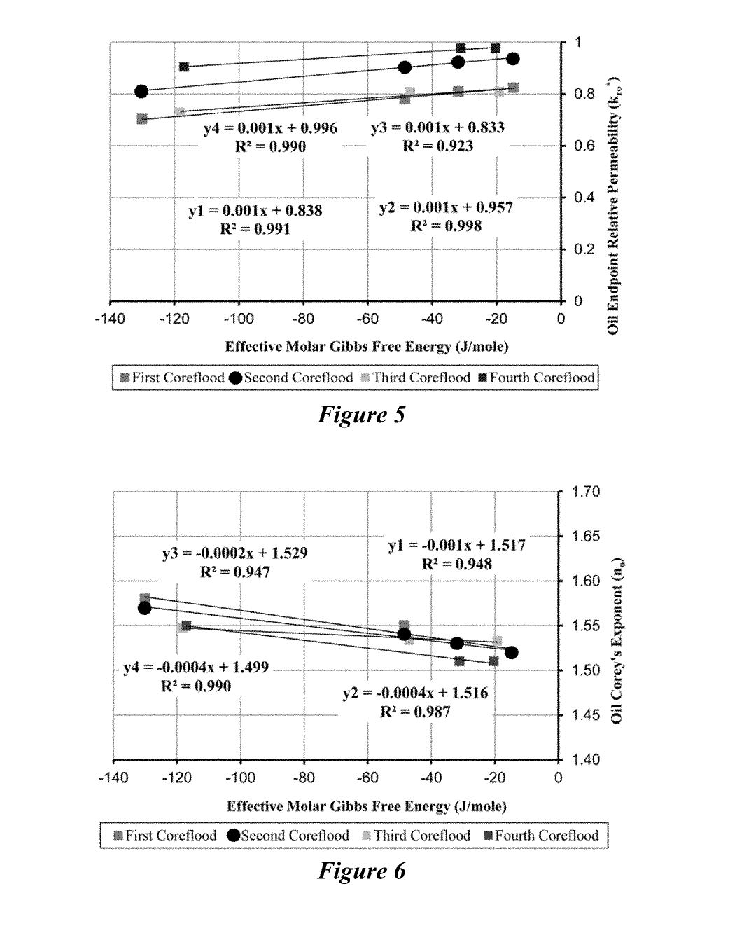

The oil endpoint relative permeability (kᵣₒ*) is expressed as a linear function of effective molar Gibbs free energy as shown in FIG. 5. The linear relationship holds for the four coreflood experiments and indicates that with decreasing salinity of the injected water, the effective molar Gibbs free energy increases and, hence, oil endpoint relative permeability increases.

A linear relationship is also proposed for oil Corey's exponent (nₒ) as a function of effective molar Gibbs free energy. This relation is shown in FIG. 6 for the four corefloods and suggests that with decreasing salinity of the injected water, the effective molar Gibbs free energy increases and, hence, oil Corey's exponent decreases.

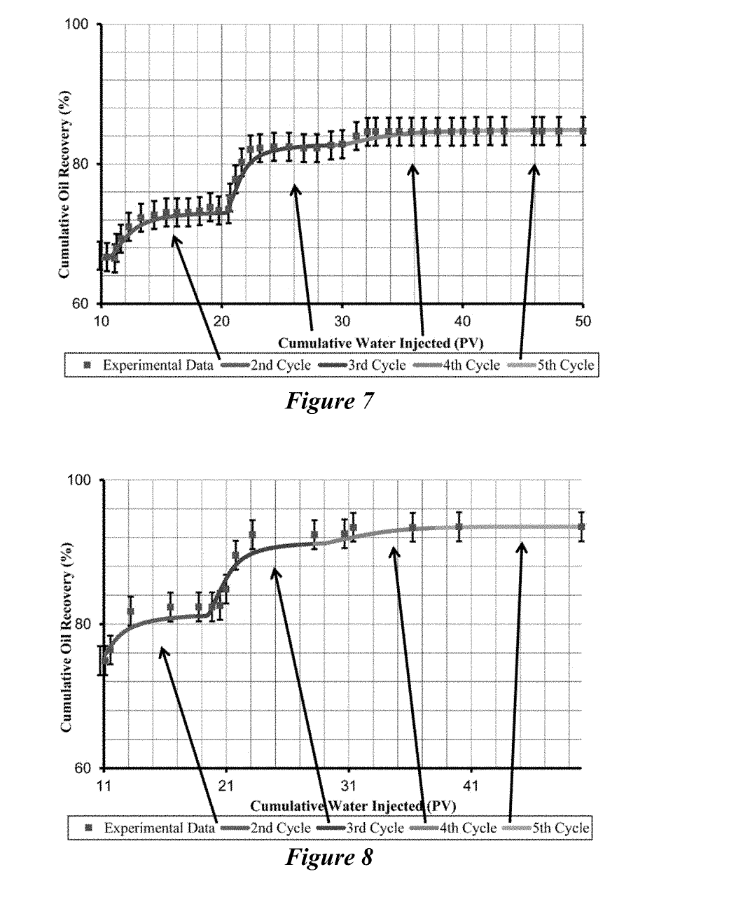

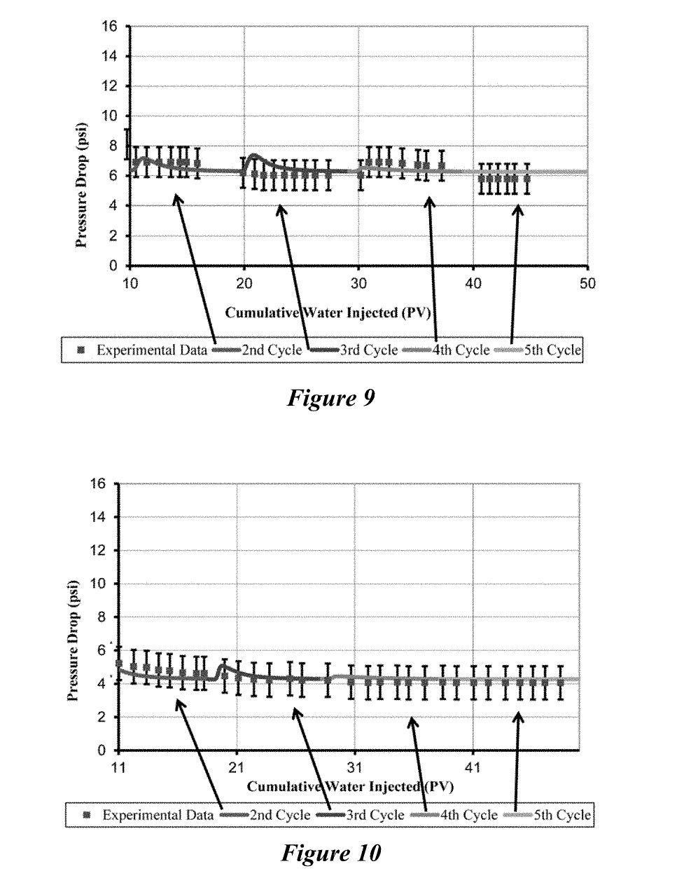

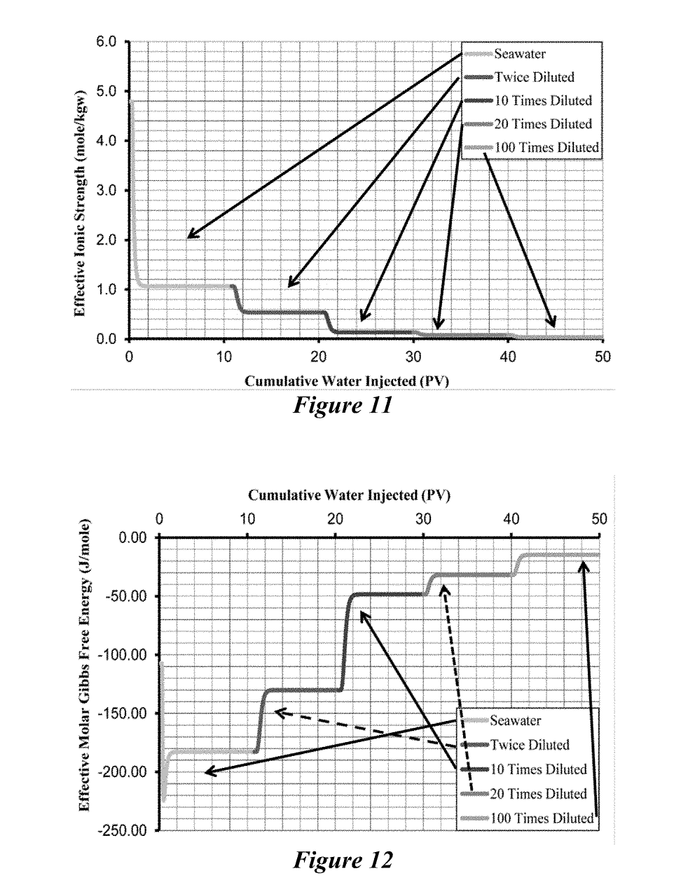

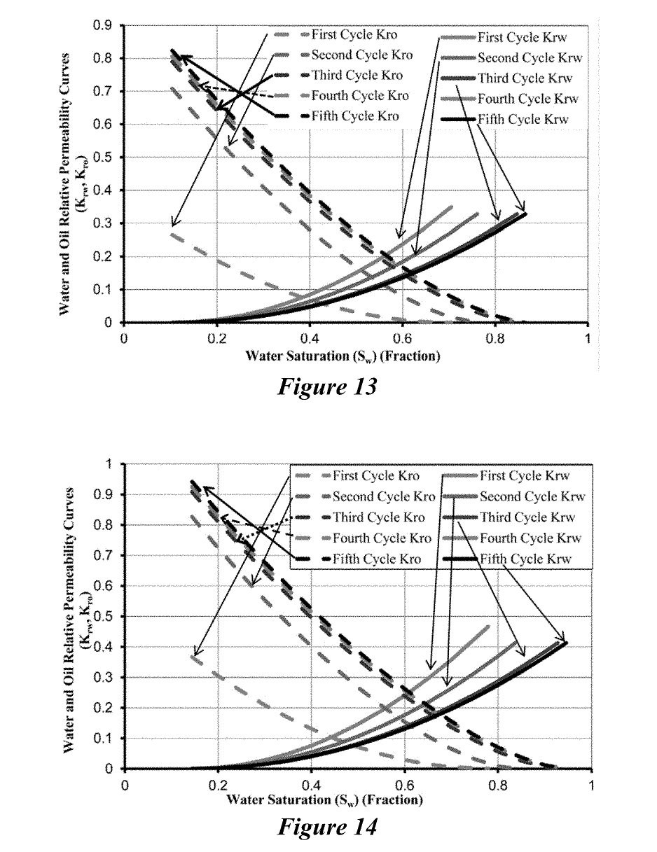

History matching of both the first and second corefloods using the proposed Mechanistic LSWI Model is included in this section (Yousef A A et al. SPE Reservoir Evaluation & Engineering Journal, SPE 137634, 2011, 14(5), 578-593). The results of cumulative oil recovery history matching for the first and second corefloods are shown in FIG. 7 and FIG. 8, respectively. FIG. 7 and FIG. 8 show a reasonable match with the experimental data within the defined 2% error in oil recovery. In addition, a reasonable pressure drop match was obtained for the first and second within the defined error bars of 2 psi (FIG. 9 and FIG. 10). The effective ionic strength and molar Gibbs free energy calculated for both first and second corefloods are shown in FIG. 11 and FIG. 12, respectively. These figures show that with decreasing salinity of the injected seawater, the effective ionic strength decreases, and the effective molar Gibbs free energy increases. The sets of relative permeability curves used for the first and second corefloods are depicted in FIG. 13 and FIG. 14.

The proposed mechanistic model for LSWI is validated using the third coreflood (Yousef A A et al. SPE 154076, 2012, Eighteenth SPE Improved Oil Recovery Symposium, Tulsa, Okla., USA) and the fourth coreflood (Chandrasekhar S and Mohanty K K. SPE 166280, 2013, ATCE, New Orleans, La.). For the first, second and third corefloods, the effluent concentrations of different species were not reported and, hence, predictions are obtained using the updated geochemical model in the UTCHEM simulator (Yousef A A et al. SPE Reservoir Evaluation & Engineering Journal, SPE 137634, 2011, 14(5), 578-593; Yousef A A et al. SPE 154076, 2012, Eighteenth SPE Improved Oil Recovery Symposium, Tulsa, Okla., USA). On the other hand, the effluent concentrations of different aqueous species are reported for the fourth coreflood and, hence, history matching of these concentrations should be performed before applying the proposed mechanistic model (Chandrasekhar S and Mohanty K K. SPE 166280, 2013, ATCE, New Orleans, La.).

History matching of the aqueous species concentrations for the fourth coreflood will now be discussed. Several low salinity water injection corefloods at temperature of 248° F. and atmospheric pressure conditions were conducted by Chandrasekhar (Chandrasekhar S. Wettability Alteration with Brine Composition in High Temperature Carbonate Reservoirs. Petroleum & Geosystems Engineering, The University of Texas at Austin, Master Thesis, 2013). One of these corefloods was simulated using the updated version of UTCHEM to history match the effluent concentrations of different aqueous species. In this coreflood, seawater was injected at irreducible water saturation conditions and then followed by twice, 10 times, and 20 times diluted seawater. In each injection cycle, the injection continues until ultimate oil recovery is reached. The compositions of formation water, seawater, twice, 10 times, and 20 times diluted seawater are shown in Table 5. The rock lithology comprises of 95% calcite and 5% dolomite.

TABLE 5
Compositions of water samples used in Chandrasekhar and Mohanty
(Chandrasekhar S and Mohanty KK. SPE 166280, 2013,
ATCE, New Orleans, Louisiana)

| | Concentrations (ppm) | | | | |
|---|---|---|---|---|---|
| | Field Connate | Sea | Twice | 10 Times | 20 Times |
| Ion | Water | Water | Diluted | Diluted | Diluted |
| Na | 49933 | 13700 | 6850 | 1370 | 685 |
| Ca | 14501 | 521 | 260.5 | 52.1 | 26.05 |
| Mg | 3248 | 1620 | 810 | 162 | 81 |
| Sulfate | 234 | 3310 | 1655 | 331 | 165.5 |
| Chloride | 111810 | 24468 | 12234 | 2446.8 | 1223.4 |
| Carbonate | 0 | 0 | 0 | 0 | 0 |
| TDS | 179726 | 43619 | 21809.5 | 4361.9 | 2180.95 |

The values of the equilibrium constants for the independent fluid species were assumed to be equal to unity. Moreover, the equilibrium constant or solubility product reported values were obtained from the PHREEQC simulator data base (phreeqc.dat) after conversion at reservoir temperature using the van′t Hoff isochore equation and correction in terms of independent fluid species. Table 6 lists the aqueous and solid species used for the fourth coreflood. The list of reactions used in the simulation run along with the corresponding equilibrium constant or solubility product are shown in Table 7.

TABLE 6
List of elements and reactive species used for the fourth coreflood

| | |
|---|---|
| Elements or | Calcium, Sodium, Magnesium, Sulfate, |
| Pseudo-elements | Carbonate, hydrogen, Chloride |
| Independent | Ca²⁺, Na⁺, Mg²⁺, SO₄²⁻, CO₃²⁻, H⁺, H₂O |
| Aqueous Species | |
| Dependent | Ca(OH)⁺, Mg(OH)⁺, Ca(HCO₃)⁺, Mg(HCO₃)⁺, OH⁻, |
| | HCO₃⁻, CaCO_{3 (aq)}, |
| Aqueous Species | MgCO_{3 (aq)}, HSO₄⁻, CaSO_{4 (aq)}, CaHSO₄⁺, MgSO_{4 (aq)}, |
| | NaCO₃⁻, NaHCO_{3 (aq)}, NaSO₄⁻, NaOH_{(aq)} |
| Solid Species | Calcite (CaCO₃), Dolomite (CaMg(CO₃)₂) |

TABLE 7
List of reactions used in the simulation run for the fourth coreflood

| Aqueous Reactions | Equilibrium Constant (245° F.) |
|---|---|
| ${Ca}^{2 +} + {H}_{2} O {⇄}^{{K}_{1}^{eq}} {CaOH}^{+} + {H}^{+}$ | ${K}_{1}^{eq} = \frac{[ {CaOH}^{+} ] [ {H}^{+} ]}{[ {Ca}^{2 +} ]} = 1.66 \times {10}^{- 13}$ |
| ${Mg}^{2 +} + {H}_{2} O {⇄}^{{K}_{2}^{eq}} {MgOH}^{+} + {H}^{+}$ | ${K}_{2}^{eq} = \frac{[ {MgOH}^{+} ] [ {H}^{+} ]}{[ {Mg}^{2 +} ]} = 2.43 \times {10}^{- 9}$ |
| ${Ca}^{2 +} + {CO}_{3}^{2 -} {⇄}^{{K}_{3}^{eq}} {CaHCO}_{3}^{+}$ | ${K}_{3}^{eq} = \frac{[ {CaHCO}_{3}^{+} ]}{[ {Ca}^{2 +} ] [ {CO}_{3}^{2 -} ] [ {H}^{+} ]} = 5.27 \times {10}^{11}$ |
| ${Mg}^{2 +} + {CO}_{3}^{2 -} + {H}^{+} {⇄}^{{K}_{4}^{eq}} {MgHCO}_{3}^{+}$ | ${K}_{4}^{eq} = \frac{[ {Mg HCO}_{3}^{+} ]}{[ {Mg}^{2 +} ] [ {CO}_{3}^{2 -} ] [ {H}^{+} ]} = 5.61 \times {10}^{11}$ |
| ${H}_{2} O {⇄}^{{K}_{5}^{eq}} {H}^{+} + {OH}^{-}$ | K₅^{eq} = [H⁺][OH⁻] = 1.11 × 10⁻¹² |
| ${CO}_{3}^{2 -} + {H}^{+} {⇄}^{{K}_{6}^{eq}} {HCO}_{3}^{-}$ | ${K}_{6}^{eq} = \frac{[ {HCO}_{3}^{-} ]}{[ {H}^{+} ] [ {CO}_{3}^{2 -} ]} = 1.67 \times {10}^{10}$ |
| ${Ca}^{2 +} + {CO}_{3}^{2 -} {⇄}^{{K}_{7}^{eq}} {CaCO}_{3}$ | ${K}_{7}^{eq} = \frac{[ {CaCO}_{3} ]}{[ {Ca}^{2 +} ] [ {CO}_{3}^{2 -} ]} = 2.26 \times {10}^{4}$ |
| ${Mg}^{2 +} + {CO}_{3}^{2 -} {⇄}^{{K}_{8}^{eq}} {MgCO}_{3}$ | ${K}_{8}^{eq} = \frac{[ {MgCO}_{3} ]}{[ {Mg}^{2 +} ] [ {CO}_{3}^{2 -} ]} = 4.10 \times {10}^{3}$ |
| ${SO}_{4}^{2 -} + {H}^{+} {⇄}^{{K}_{9}^{eq}} {HSO}_{4}^{-}$ | ${K}_{9}^{eq} = \frac{[ {HSO}_{4}^{-} ]}{[ {H}^{+} ] [ {SO}_{4}^{2 -} ]} = 1.32 \times {10}^{3}$ |
| ${Ca}^{2 +} + {SO}_{4}^{2 -} {⇄}^{{K}_{10}^{eq}} {CaSO}_{4}$ | ${K}_{10}^{eq} = \frac{[ {CaSO}_{4} ]}{[ {Ca}^{2 +} ] [ {SO}_{4}^{2 -} ]} = 3.05 \times {10}^{2}$ |
| ${Ca}^{2 +} + {SO}_{4}^{2 -} + {H}^{+} {⇄}^{{K}_{11}^{eq}} {CaHSO}_{4}^{+}$ | ${K}_{11}^{eq} = \frac{[ {CaHSO}_{4}^{+} ]}{[ {Ca}^{2 +} ] [ {SO}_{4}^{2 -} ] [ {H}^{+} ]} = 1.59 \times {10}^{4}$ |
| ${Mg}^{2 +} + {SO}_{4}^{2 -} {⇄}^{{K}_{12}^{eq}} {MgSO}_{4}^{2 -}$ | ${K}_{12}^{eq} = \frac{[ {MgSO}_{4} ]}{[ {Mg}^{2 +} ] [ {SO}_{4}^{2 -} ]} = 1.50 \times {10}^{3}$ |
| ${CO}_{3}^{2 -} + {Na}^{+} {⇄}^{{K}_{13}^{eq}} {NaCO}_{3}^{-}$ | ${K}_{13}^{eq} = \frac{[ {NaCO}_{3}^{-} ]}{[ {Na}^{+} ] [ {CO}_{3}^{2 -} ]} = 5.94$ |
| ${Na}^{+} + {CO}_{3}^{2 -} + {H}^{+} {⇄}^{{K}_{14}^{eq}} {NaHCO}_{3}$ | ${K}_{14}^{eq} = \frac{[ {NaHCO}_{3} ]}{[ {Na}^{+} ] [ {CO}_{3}^{2 -} ] [ {H}^{+} ]} = 3.57 \times {10}^{10}$ |
| ${SO}_{4}^{2 -} + {Na}^{+} {⇄}^{{K}_{15}^{eq}} {NaSO}_{4}^{-}$ | ${K}_{15}^{eq} = \frac{[ {NaSO}_{4}^{-} ]}{[ {Na}^{+} ] [ {SO}_{4}^{2 -} ]} = 7.91$ |
| ${Na}^{+} + {H}_{2} O {⇄}^{{K}_{16}^{eq}} NaOH + {H}^{+}$ | ${K}_{16}^{eq} = \frac{[ NaOH ] [ {H}^{+} ]}{[ {Na}^{+} ]} = 1.11 \times {10}^{- 22}$ |
| Dissolution/Precipitation reactions | Solubility Product |
| ${CaCO}_{3} {⇄}^{{K}_{1}^{sp}} {Ca}^{2 +} + {CO}_{3}^{2 -}$ | K₁^{sp} = [Ca²⁺][CO₃²⁻] = 2.57 × 10⁻¹⁰ |
| ${CaMg ( {CO}_{3} )}_{2} {⇄}^{{K}_{2}^{sp}} {Ca}^{2 +} + {Mg}^{2 +} + 2 {CO}_{3}^{2 -}$ | K₂^{sp} = [Ca²⁺][Mg²⁺][CO₃²⁻]² = 1.74 × 10⁻¹⁹ |

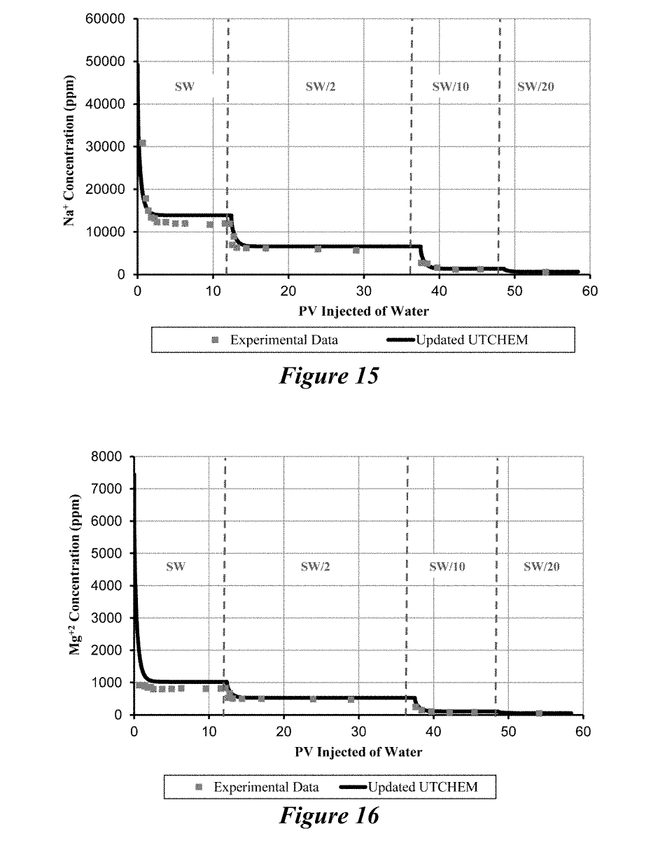

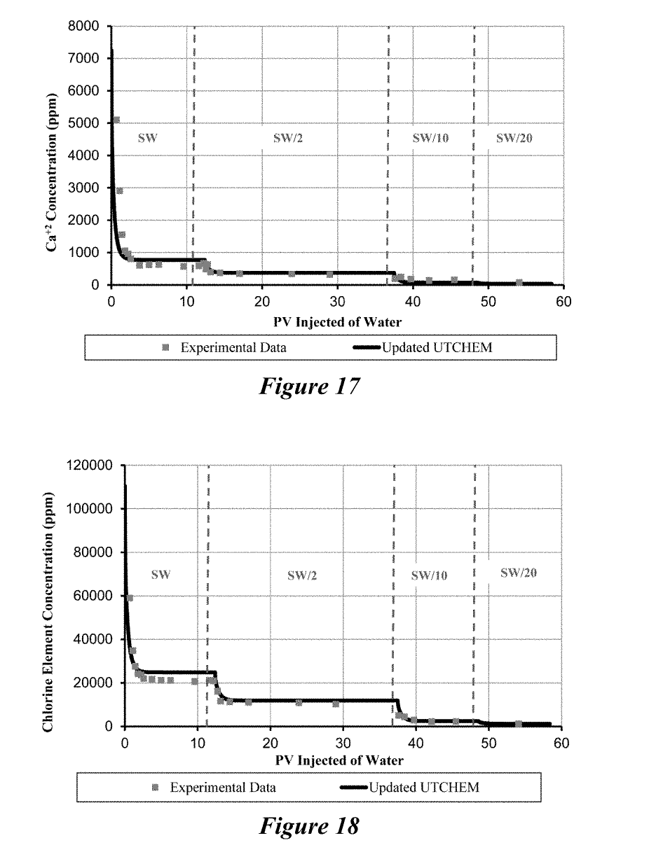

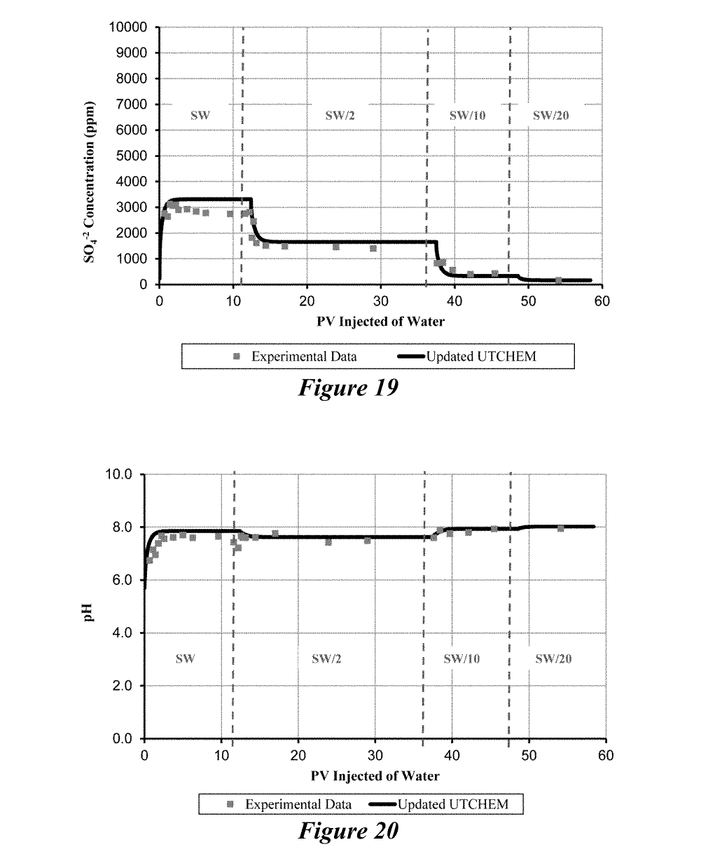

The results of history matching are depicted in FIG. 15 to FIG. 20, which show a reasonable history matching of effluent concentrations using the updated geochemistry model in UTCHEM. History matching of effluent concentrations of Chandrasekhar validates the new geochemical implementations in UTCHEM (Chandrasekhar S. Wettability Alteration with Brine Composition in High Temperature Carbonate Reservoirs. Petroleum & Geosystems Engineering, The University of Texas at Austin, Master Thesis, 2013). Moreover, the trend of increasing pH number as a result of low salinity water injection was captured using the new implementation.

The third coreflood was used to validate the proposed mechanistic model (Yousef A A et al. SPE 154076, 2012, Eighteenth SPE Improved Oil Recovery Symposium, Tulsa, Okla., USA). The residual oil saturation was adjusted as a function of effective molar Gibbs free energy (FIG. 4). Table 8 shows the absolute error calculated between modeled and experimental residual oil saturations, which gave a reasonable amount of error (e.g., ≦0.02). The previously proposed models for oil Corey's exponent and endpoint relative permeability as functions of effective molar Gibbs free energy were applied to the third coreflood (Yousef A A et al. SPE 154076, 2012, Eighteenth SPE Improved Oil Recovery Symposium, Tulsa, Okla., USA) (FIG. 5 and FIG. 6). The FIG. 5 and FIG. 6 show the linear relationship of both the oil Corey's exponent and endpoint relative permeability as functions of effective molar Gibbs free energy. The relation suggest that as the salinity of injected water decreases, effective molar Gibbs free energy increases which leads to an increase in oil endpoint relative permeability and decrease in oil Corey's exponent. Hence, rendering the rock towards a more water-wet state and incremental oil recovery is obtained.

TABLE 8
Absolute error between experimental and modeled residual oil
saturation using the Mechanistic LSWI Model for the third coreflood.

| | Effective | | | | |
|---|---|---|---|---|---|
| | Molar Gibbs | Third Coreflood | | | |
| Water | Free Energy | Experimental | | Modeled | Absolute |
| Type | (J/mole) | Sₒᵣ | ωS | Sₒᵣ | Error |
| Seawater | −164.23 | 0.245 | — | — | — |
| 2x Diluted | −118.14 | 0.188 | 0.318 | 0.208 | 0.020 |
| 10x | −46.83 | 0.143 | 0.809 | 0.152 | 0.009 |
| Diluted | | | | | |
| 100x | −19.20 | 0.130 | 1 | 0.130 | 0.000 |
| Diluted | | | | | |

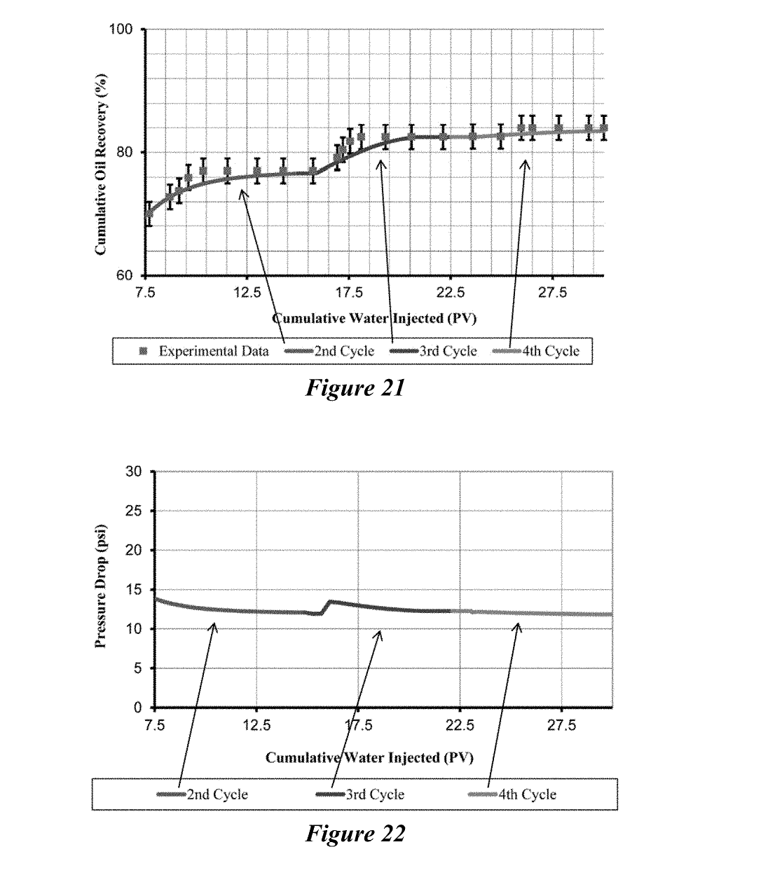

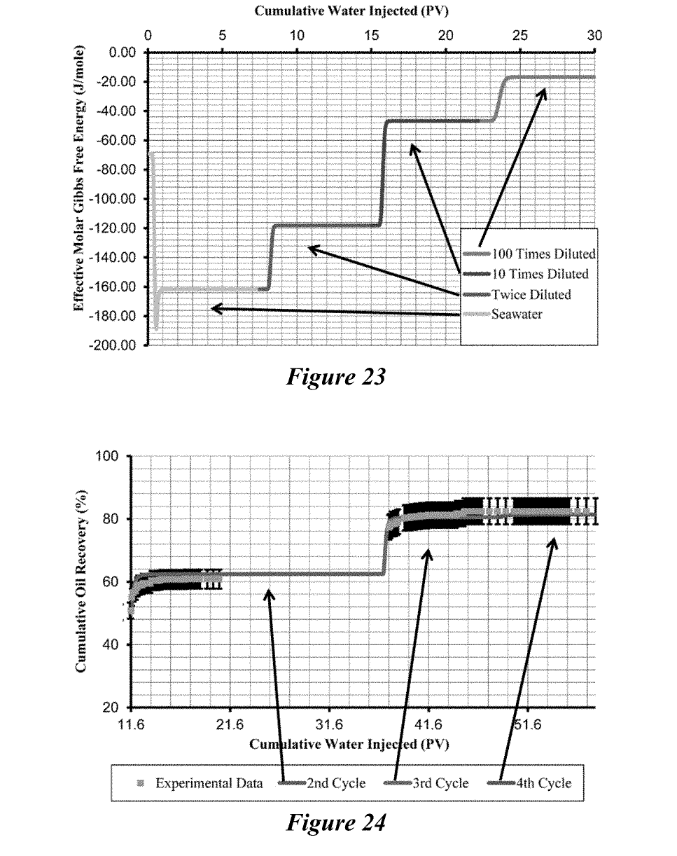

The third coreflood has the same connate and injected water compositions, and rock lithology compared to the first and second corefloods (Yousef A A et al. SPE Reservoir Evaluation & Engineering Journal, SPE 137634, 2011, 14(5), 578-593; and 2012). Hence, the elements, independent and depend aqueous species, and solid species considered in reaction equilibria are similar (Al-Shalabi E W et al. SPE 169101, 2014, SPE Improved Oil Recovery Symposium, Okla., USA). Nevertheless, this coreflood was run at 135° F. while the other corefloods were run at 212° F. Hence, correction for equilibrium constant (K_{eq}) and solubility product (Kₛₚ) for different reaction equilibria was needed. Moreover, the A and B constants in the Extended or WATEQ Debye-Huckel Equation were corrected at 135° F. Oil recovery history matching for the third coreflood is depicted in FIG. 21 where a reasonable oil recovery match was obtained (Yousef A A et al. SPE 154076, 2012, Eighteenth SPE Improved Oil Recovery Symposium, Tulsa, Okla., USA). A prediction for pressure drop is shown in FIG. 22 for the third coreflood. The effective molar Gibbs free energy for the third coreflood is shown in FIG. 23.

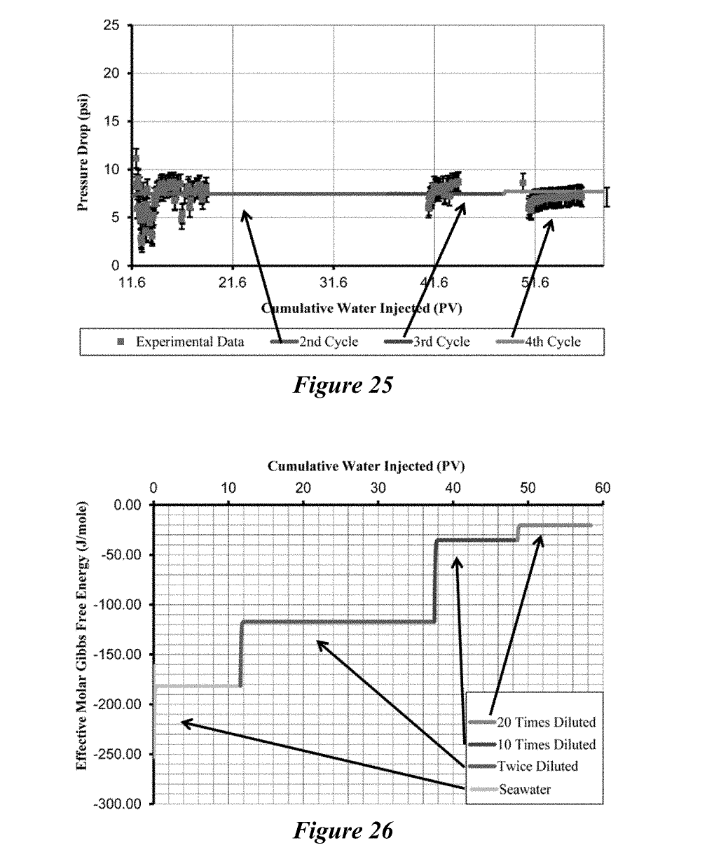

The fourth coreflood was also used to validate the proposed model (Chandrasekhar S and Mohanty K K. SPE 166280, 2013, ATCE, New Orleans, La.). Similarly, residual oil saturation, oil Corey's exponent, and oil endpoint relative permeability were adjusted as functions of effective molar Gibbs free energy (FIG. 4-FIG. 6). Table 9 shows the absolute error calculated between modeled and experimental residual oil saturations, which is an acceptable amount of error (e.g., ≦0.02). Lists of aqueous and solid species along with the reactions used in the geochemical modeling of this coreflood were previously shown in Table 6 and Table 7, respectively. Both oil recovery and pressure drop history matchings for the fourth coreflood are depicted in FIG. 24 and FIG. 25, respectively. The effective molar Gibbs free energy for the fourth coreflood is shown in FIG. 26.

TABLE 9
Absolute error between experimental and modeled residual oil
saturation using the Mechanistic LSWI Model for the fourth coreflood.

| | Effective | | | | |
|---|---|---|---|---|---|
| | Molar Gibbs | Fourth Coreflood | | | |
| | Free Energy | Experimental | | Modeled | Absolute |
| Water Type | (J/mole) | Sₒᵣ | ωS | Sₒᵣ | Error |
| Seawater | −174.64 | 0.329 | — | — | — |
| 2x Diluted | −117.02 | 0.267 | 0.401 | 0.248 | 0.019 |
| 10x Diluted | −31.10 | 0.127 | 1 | 0.127 | 0.000 |
| 100x Diluted | −20.32 | 0.127 | 1 | 0.127 | 0.000 |

Mechanistic modeling of the effect of LSWI on oil recovery from carbonate rocks was performed successfully by history matching for the first and second corefloods (Yousef A A et al. SPE Reservoir Evaluation & Engineering Journal, SPE 137634, 2011, 14(5), 578-593). In the proposed mechanistic LSWI model, residual oil saturation and oil relative permeability curves are functions of effective molar Gibbs free energy while maintaining constant water relative permeability curves. The new geochemical implementations in UTCHEM were validated by history matching the effluent concentrations for different aqueous species of the fourth coreflood (Chandrasekhar S and Mohanty K K. SPE 166280, 2013, ATCE, New Orleans, La.). The mechanistic model was validated by history matching the third and fourth corefloods (Yousef A A et al. SPE 154076, 2012, Eighteenth SPE Improved Oil Recovery Symposium, Tulsa, Okla., USA, and Chandrasekhar S and Mohanty K K. SPE 166280, 2013, ATCE, New Orleans, La.). By matching the fourth coreflood, the applicability of the mechanistic model is extended to include weakly-oil-wet as well as mixed-wet carbonate rocks (Chandrasekhar S and Mohanty K K. SPE 166280, 2013, ATCE, New Orleans, La.). The mechanistic model captures both wettability alteration and/or dissolution/fine migration effects on oil recovery through changes in molar Gibbs free energy. This model can be used for oil recovery predictions and optimization of field applications in both carbonate and sandstone oil reservoirs.

### Example 2

Field applications of tracers have demonstrated remarkable roles in determining important reservoir characteristics, such as reservoir heterogeneity and fluid saturations. Tracer tests are classified into inter-well (IWTT) and single-well tests (SWTT). In the inter-well tests, tracers are injected into one or more wells and produced from others. Nevertheless, in the single-well tracer test, tracers are injected into and then produced from the same well. These two tests have different advantages and disadvantages. For example, inter-well tracer tests have access to larger areas of the investigated reservoirs, upon which more information can be gained; however, tracer recovery can take up to several years and the analysis can be very complex (Sharma A et al. SPE 169109, 2014, SPE Improved Oil Recovery Symposium, Tulsa, Okla., USA). Among the information gained from inter-well tests are: the general trends of fluid movements, layering, areal heterogeneity, directional flow trends, and saturations (Allison S B. Analysis and Design of Field Tracers for Reservoir Description. Master Thesis, 1988, The University of Texas at Austin, Austin, Tex., USA). On the other hand, the single-well tracer test takes fewer than three weeks to complete and there is less uncertainty in the analysis due to the restriction to a small area of the investigated reservoir, which limits the amount of information gained from this test (Descant F J. Simulation of Single-Weil Tracer Flow. Master Thesis, 1989, The University of Texas at Austin, Austin, Tex., USA).

The single well chemical tracer test (SWCTT) is also known as the residual oil saturation tracer test and the Exxon tracer test. This test uses chemical reactions involving different tracers. The primary objective of single-well tracer tests is to determine fluid saturation. Other applications of this test include wettability-determining and permeability-determining tracer tests (Descant F J. Simulation of Single-Weil Tracer Flow. Master Thesis, 1989, The University of Texas at Austin, Austin, Tex., USA).

Determination of residual oil saturation using SWCTT uses the chromatographic separation of tracers with different partition coefficients, in conjunction with a tracer reaction (Tomich J F et al. Journal of Petroleum Technology, 1973, 255: 211-218). The theory and execution of the test includes the effects of fluid drift and other non-deal effects (Deans H A and Majoros S. The Single-Well Chemical Tracer Method for Measuring Residual Oil Saturation. US. DOE Report BC/20006-18, 1980). Another method for testing enhanced oil recovery process in a single well involves using different residual oil saturation tracer tests including multiple reacting tracers, each with a different radius of investigation (Sheely C Q and Baldwin D E. Journal of Petroleum Technology, 1982, 34(8), 1887-1896). A single-well method to measure connate water saturation has also been proposed, which is the same as the residual oil saturation tests; however, oil is the mobile phase instead of water (Deans H A and Shallenberger L K. SPE 4755, 1976, SPE/AIME Symposium on Improved Oil Recovery, Tulsa, Okla., USA). Another method to measure residual oil saturation uses chromatographic separation of tracers and fluid drift, instead of a tracer reaction (U.S. Pat. No. 3,902,362).

The single-well chemical tracer test can be used to evaluate the efficiency of enhanced oil recovery (EOR) processes. Herein, the focus is on the low salinity water injection (LSWI) technique. LSWI is an enhanced oil recovery technique that can be used at both laboratory and field scales and that reduces residual oil saturation via a combination of intertwined mechanisms.

The interest in low salinity water injection (LSWI) is increasing in both laboratory and field tests compared to seawater injection or high salinity produced brine injection. The single well chemical tracer test (SWCTT) is also becoming increasingly popular as an in situ test to assess the reduction in oil saturation due to an enhanced oil recovery (EOR) process. Hence, accurate modeling of single well chemical tracer field tests (SWCTTs) is essential.

Herein, modeling and simulation of SWCTT of low salinity water injection in a carbonate reservoir was investigated using the UTCHEM reservoir simulator. Both Radial and Cartesian grid models were setup for a field-scale pilot test using measured rock and fluid data from a Middle Eastern reservoir. Tracer reactions, along with the empirical LSWI model implemented in UTCHEM, were used to estimate residual oil saturation as a result of low salinity water injection. Two approaches were used to estimate remaining oil saturation to LSWI including analytical and numerical methods. The results showed that both approaches give consistent values for remaining oil saturation for the homogeneous Radial grid model. The Cartesian grid model was used to investigate the effect of heterogeneity on the SWCTT results, where a new numerical approach is proposed for estimating remaining oil saturation. This finding validates the approach used and the implementation of both tracer reactions and the LSWI model in UTCHEM. The proposed approach can thus be used to estimate remaining oil saturation of the SWCTT for reservoirs with different degrees of heterogeneity, which provides a clear insight into reservoir performance before planning multi-well demonstration pilots.

This work represents a synthetic single-well chemical tracer test with a real fluid and rock properties of a Middle Eastern reservoir. The SWCTT was simulated at temperature of 173° F. and an initial pressure of 750 psi. Rock petrophysical properties are listed in Table 10. The simulated pilot has an average porosity of 13.4% and average liquid permeability of 348 mD. Moreover, Table 10 shows the properties of formation water, seawater, and twenty times diluted seawater (SW/20) as well as crude oil properties. The assigned operating conditions for the well injection and production rates are 500 and 300 bbls/day, respectively. The reservoir model is initially at residual oil saturation to seawater (S_{orw}) ratio of 0.37, as if large numbers of seawater pore volumes were injected until there is no more change in oil saturation of the investigated zone before conducting the LSWI.

TABLE 10
Reservoir and fluid properties

| | Value | |
|---|---|---|
| | English | |
| Parameter | Units | SI units |
| Average Porosity | 0.132 | 0.134 |
| Average Permeability (mD) | 348 | 348 |
| Initial Pressure | 750 psi | 5.17 × 10⁶ Pa |
| Depth | 4700 ft | 1410 m |
| Water-Oil IFT (mN.m) | 19.95 | 19.95 |
| Reservoir Temperature | 173° F. | 78.3° C. |
| Oil Viscosity (cP) at Reservoir | 5 | 5 |
| Temperature | | |
| Seawater Viscosity (cP) at Reservoir | 0.72 | 0.72 |
| Temperature | | |
| 20 times Diluted Seawater Viscosity (cP) | 0.233 | 0.233 |
| at Reservoir Temperature | | |
| Oil Density at Reservoir Temperature | 54.31 lb/ft³ | 0.87 g/cc |
| Seawater Density at Reservoir | 62.37 lb/ft³ | 0.999 g/cc |
| Temperature | | |
| 20 Times Diluted Seawater Density at | 58.99 lb/ft³ | 0.945 g/cc |
| Reservoir Temperature | | |
| Formation Water Salinity (meq/ml) | 6.892 | 6.892 |
| Seawater Salinity (meq/ml) | 2 | 2 |
| 20 Times Diluted Seawater Salinity | 0.1 | 0.1 |
| (meq/ml) | | |
| Initial Oil Saturation (Sₒᵢ) | 0.707 | 0.707 |
| Residual Oil Saturation to water (S_{orw}) | 0.37 | 0.37 |
| Well Injection Rate | 500 bbl/d | 79.49 m³/d |
| Well Production Rate | 300 bbl/d | 47.69 m³/d |

The numerical simulations were performed using UTCHEM, a three dimensional non-isothermal chemical compositional reservoir simulator. UTCHEM has the capability of modeling chemical enhanced/improved oil recovery processes such as polymer, surfactant, alkaline, and low salinity water flooding, among others. UTCHEM uses a third-order TVD finite-difference numerical technique to control numerical dispersion. The method used to solve flow equations is implicit in pressure and explicit in concentration (UTCHEM manual, 2011). A two-dimensional (r-z) radial coordinate option was added to the existing three-dimensional Cartesian coordinate in the UTCHEM simulator (Descant F J. Simulation of Single-Weil Tracer Flow. Master Thesis, 1989, The University of Texas at Austin, Austin, Tex., USA). The radial option has the same formulation as the Cartesian coordinate version of UTCHEM. This radial option models two-dimensional radial flow to and from a single well. The reservoir is assumed to be horizontal upon which the depth does not change with radius. More details about the radial coordinate option can be found elsewhere (Descant F J. Simulation of Single-Weil Tracer Flow. Master Thesis, 1989, The University of Texas at Austin, Austin, Tex., USA). Radial and Cartesian simulation models were used to simulate the LSWI-SWCTT with emphasis on capturing reservoir heterogeneity and its effect on estimating average residual oil saturation. A description of each simulation model is described in this section.

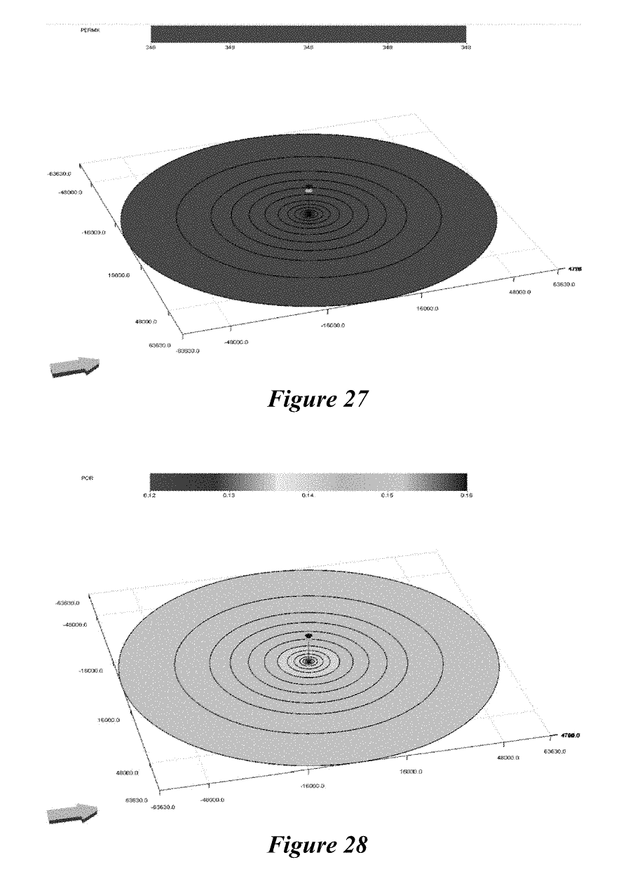

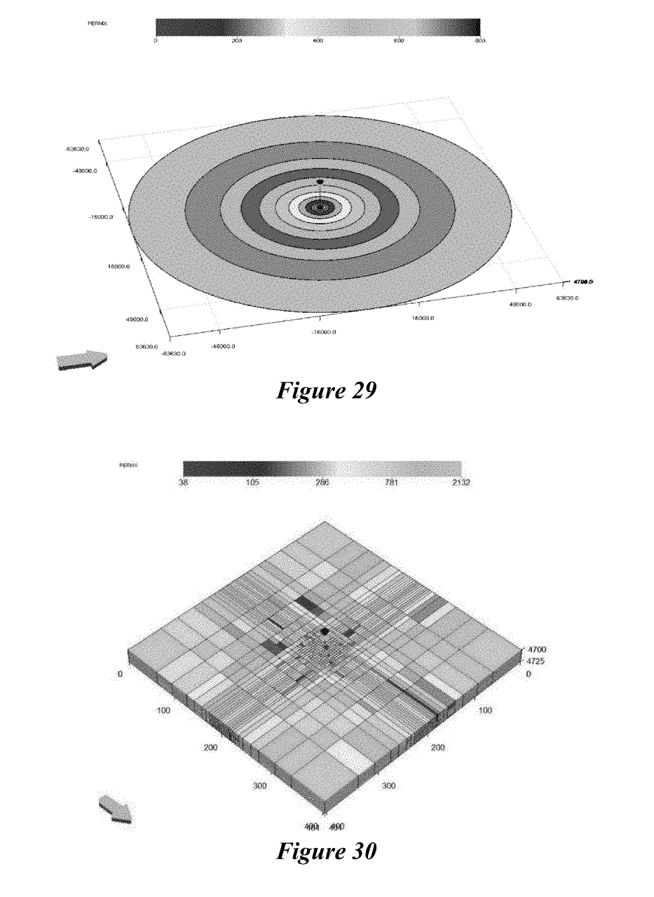

One-dimensional (1D) simulation models were developed for simulating the low salinity SWCTT, including homogeneous and heterogeneous models. The specifications of the 1D models (24×1×1) are listed in Table 11. Table 11 shows that fine gridblock sizes were used in the vicinity of the wellbore to obtain a higher resolution and a more accurate estimation of residual oil saturation. The assigned radius of investigation was 232 ft. The model with homogeneous permeability is shown in FIG. 27. For the heterogeneous model, random porosity and permeability were generated and assigned for different gridblocks. Porosity and permeability maps used for the heterogeneous model are shown in FIG. 28 and FIG. 29, respectively.

TABLE 11
Specifications of the radial model used for LSWI-SWCTT

| Parameter | Value | Comments |
|---|---|---|
| Number of | 24 (24 × 1 × 1) | Radial Coordinate |
| Gridblocks | | System |
| Gridblock | ΔR: 5 × 1, 3 × 2, 3 × 4, 3 × 8, | Variable Grid Size |
| Sizes | 3 × 15, 5 × 20, 40 ft | (wellbore radius is |
| | ΔZ: 25 ft | counted as the first |
| | (ΔR: 5 × 0.3, 3 × 0.6, 3 × 1.2, | gridblock with 0.25 ft or |
| | 3 × 2.4, 3 × 4.5, | 0.075 m) |
| | 5 × 6, 12 m | |
| | ΔZ: 7.5 m) | |
| Model | 232 ft × 25 ft | Length × Thickness |
| Dimensions | (69.6 m × 7.5 m) | |

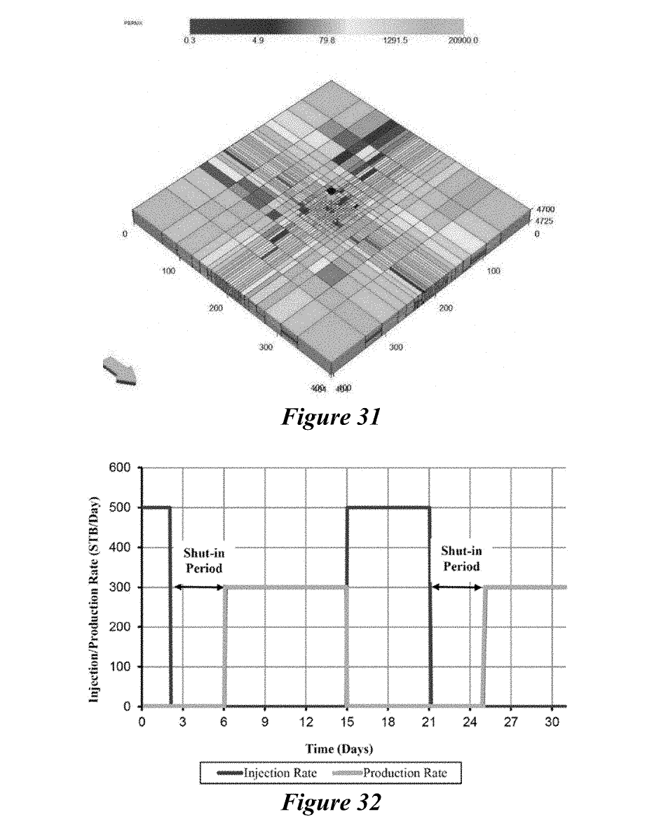

A Cartesian simulation model was used with 27×27×10 gridblocks. The thickness of the reservoir was the same as that in the radial model. The width and length (both 123 m (404 ft)) form a cube with the same area as the circle in the radial model. Because the tracer transport is near the well in SWCTT, a locally refined grid was used for simulation to focus on the near-well flow and transport (Table 12). Cartesian grid models were introduced to highlight the effect of heterogeneity on estimating residual oil saturation. Heterogeneous models were setup by generating permeability distribution with an arithmetic mean of 348 mD and varying Dykstra Parson's coefficient (V_{DP}) of 0.4 and 0.8, which represents moderate and strong heterogeneity, respectively. A spherical variogram and a log normal permeability distribution were used. A spherical variogram model was used to express the heterogeneity in the carbonate rocks, as it represents an average heterogeneity level compared to an exponential model (high heterogeneity level) and Gaussian model (low heterogeneity level). To focus on the effect of heterogeneous permeability, the porosity was considered to be constant (0.134). The horizontal correlation lengths in the x and y directions were assumed to be the same (10 ft), and the ratio of the horizontal to vertical correlation lengths was 1. A program based on the matrix decomposition method (MDM) was used for generating the stochastic permeability distribution (Yang A P. Stochastic Heterogeneity and Dispersion. PhD Dissertation, 1990, The University of Texas at Austin, Tex., USA). FIG. 30 and FIG. 31 show the heterogeneous Cartesian models with V_{DP} of 0.4 and 0.8, respectively. Small longitudinal (0.1524 m (0.5 ft)) and transverse dispersivities of (0.012 m (0.04 ft)) were used, because the model permeability heterogeneity already induces mixing for the salt component.

TABLE 12
Specifications of Cartesian Model used for LSWI-SWCTT

| Parameter | Value | Comments |
|---|---|---|
| Number of | 72903D (27 × 27 × 10) | Cartesian |
| Gridblocks | | Coordinate |
| | | System |
| Gridblock | Δx: 64, 2 × 32, 2 × 16, 2 × 8, 13 × 4, 2 × 8, | Gridblock |
| Sizes (Δx, | 2 × 16, 2 × 32, 64 ft | Size in x, y, |
| Δy, Δz) | Δy: 64, 2 × 32, 2 × 16, 2 × 8, 13 × 4, 2 × 8, | and z |
| | 2 × 16, 2 × 32, 64 ft | Directions |
| | Δz: 10 × 2.5 ft | |
| | (Δx: 19.2, 2 × 9.6, 2 × 4.8, 2 × 2.4, | |
| | 13 × 1.2, 2 × 2.4, 2 × 4.8, 2 × 9.6, 19.2 m | |
| | Δy: 19.2, 2 × 9.6, 2 × 4.8, 2 × 2.4, 13 × 1.2, | |
| | 2 × 2.4, 2 × 4.8, 2 × 9.6, 19.2 m | |
| | Δz: 10 × 0.75 m) | |
| Model | 404 ft × 404 ft × 25 ft | Length × |
| Dimensions | (121.2 m × 121.2 m × 7.5 m) | Width × |
| | | Thickness |

Any number of tracers can be modeled including water tracer, oil tracer, partitioning oil/water tracer, gas tracer, and partitioning gas/oil tracer. Reacting tracers are considered only for water/oil tracers. In the modeling of tracers, it was assumed that tracers neither occupy volume nor have effect on the physical properties. The overall tracer concentrations were computed from the species conservation equations, which include a reaction term for the reacting tracer. On the other hand, the tracer phase concentrations were calculated according to the tracer type: water, oil, gas, or partitioning. UTCHEM can model single-well tracer tests (Descant F J. Simulation of Single-Weil Tracer Flow. Master Thesis, 1989, The University of Texas at Austin, Austin, Tex., USA), partitioning interwell tracer tests (Allison S B et al. Journal of Petroleum Science and Engineering, 1991, 5(2), 173-186; Jin M et al. Water Resources Research Journal, 1995, 31(5), 1201-1211), and single-well wettability tracer tests (Ferreira L E A et al. SPE 24136, 1992, SPE/DOE Eighth Symposium on Enhanced Oil Recovery, Tulsa, Okla., USA).

For the non-partitioning tracers, the tracer phase concentration (C_{T}_{ₗ}) is proportional to the ratio of the total tracer concentration (C_{T}) to the total concentration of water or oil depending on the tracer type (C_{K}) as follows:

$${C}_{{T}_{l}} = {C}_{κ l} \frac{{C}_{T}}{{C}_{κ}} \qquad ( 16 )$$

where T is the tracer type including water or oil, l is the phase number, K is the component number, and Cₖₗ is the concentration of component K in phase l.

On the other hand, for partitioning tracers, the partition coefficient for a water/oil tracer is defined on the basis of water or oil pseudo-component concentration as the following:

$${K}_{T} = \frac{{C}_{T 2}}{{C}_{T 1}} \qquad ( 17 )$$

where C_{T1} and C_{T2} are the tracer concentrations in the water and oil pseudo-components. The tracer phase compositions are the calculated from the tracer material balance equation as

C_{T1}=C₁ₗC_{T1}+C₂ₗC_{T2} (18)

By substituting equation (17) into equation (18), the resulting tracer phase concentrations are

$$\begin{matrix}{C}_{T 1} = \frac{{C}_{T}}{{C}_{1} + {C}_{2} {K}_{T}} & ( 19 ) \\ {C}_{T 2} = {K}_{T} \frac{{C}_{T}}{{C}_{1} + {C}_{2} {K}_{T}} & ( 20 )\end{matrix}$$

For tracer reaction, the hydrolysis of Ethyl Acetate to Ethanol is assumed to be of first order and irreversible as follows:

$$1 {{CH}_{3} COO [ {C}_{n} {H}_{2 n + 1} ]}_{Acetate} + {1 {H}_{2} O}_{Water} \to 1 {{C}_{n} {H}_{2 n + 1} [ OH ]}_{Alcohol} + {1 {C}_{2} {H}_{4} {O}_{2}}_{Acetic Acid} \qquad ( 21 )$$

where one mole of acetate (ETAC) generates one mole of product alcohol (ETOH). The reactions are modeled as

$$\begin{matrix}\frac{\partial {c}_{ETAC}}{\partial t} = - {kc}_{ETAC} & ( 22 ) \\ \frac{\partial {c}_{ETOH}}{\partial t} = {kc}_{ETOH} & ( 23 )\end{matrix}$$

where k is the reaction constant in the unit of day⁻¹. Regional fluid drift is assumed to be negligible.

Wettability alteration is still believed to be the reason behind incremental oil recovery by low salinity water injection (LSWI). From this principle, three LSWI models were proposed and implemented in the UTCHEM simulator: empirical, fundamental, and mechanistic models.

The empirical LSWI model highlights the effect of LSWI on oil recovery through shifting oil relative permeability, adjusting residual oil saturation, and maintaining constant water relative permeability. In this model, oil relative permeability endpoint and exponent are functions of measured contact angle upon which a third degree polynomial function is used to express contact angle as function of water salinity (Al-Shalabi E W et al. SPE 169674, 2014, SPE EOR Conference at OGWA, Muscat, Sultanate of Oman). The fundamental LSWI model addresses the improvement in microscopic displacement efficiency by LSWI through adjusting capillary desaturation curve using different trapping parameters (Al-Shalabi E W et al. SPE 169911, 2014, SPE Trinidad & Tobago Energy Resources Conference, Port of Spain, Trinidad and Tobago). The mechanistic LSWI model captures the effect of different geochemical reactions on oil recovery from carbonates through calculating the effective molar Gibbs-free energy. In this model, oil relative permeability endpoint and exponent are modeled as functions of effective molar Gibbs free energy (Al-Shalabi E W et al. SPE 172770, 2015, SPE 19th Middle East Oil & Gas Show and Conference, Manama, Kingdom of Bahrain).

Herein, the empirical LSWI model is used to simulate the low salinity water injection of the designed SWCTT. The low salinity model in UTCHEM (Al-Shalabi E W et al. SPE 169674, 2014, SPE EOR Conference at OGWA, Muscat, Sultanate of Oman) can be described as:

$$\begin{matrix}{S}_{or} ( Altered ) = ω S \times {S}_{or}^{LS} + ( 1 - ω S ) \times {S}_{or}^{HS} & ( 24 ) \\ ω S = \frac{( θ - {θ}^{HS} )}{( {θ}^{LS} - {θ}^{HS} )} & ( 25 )\end{matrix}$$

where Sₒᵣ^{HS} is the residual oil saturation for the seawater cycle for this section; Sₒᵣ^{LS} is the limiting residual oil saturation by LSWI for this section; θ is the measured contact angle for the injected LSWI cycle (degrees); θ^{HS} is the measured contact angle for the seawater cycle for this section (degrees); and θ^{LS} is the measured contact angle when Sₒᵣ^{HS} is reached for this section (degrees).

$${k}_{ro}^{*} = \frac{{k}_{ro}^{* LS} - {k}_{ro}^{* HS}}{1 + {( \frac{θ}{a} )}^{e}} + {k}_{ro}^{* HS} \qquad ( 26 )$$

where k*ᵣₒ^{HS} is the experimental oil endpoint relative permeability when Sₒᵣ^{HS} is reached; k*ᵣₒ^{LS} is the simulated oil endpoint relative permeability when Sₒᵣ^{LS} is reached; a is the inflection point from curve fitting; and e is the hill slope.

$${n}_{o} = \frac{{n}_{omax} - {n}_{o}^{LS}}{1 + {( \frac{θ}{a} )}^{- e}} + {n}_{o}^{LS} \qquad ( 27 )$$

where n_{o max} is the maximum Corey's exponent for oil relative permeability with a typical value of 4; and nₒ^{LS} is Corey's exponent for oil relative permability when Sₒᵣ^{HS} is reached.

The theory behind the single-well chemical tracer test (SWCTT) and its procedure have been described fully elsewhere (Deans H A and Majoros S. The Single-Well Chemical Tracer Method for Measuring Residual Oil Saturation. US. DOE Report BC/20006-18, 1980; Tomich J F et al. Journal of Petroleum Technology, 1973, 255: 211-218). Briefly, a slug of water containing Ester Acetate (primary tracer) is injected into a reservoir that is at or near residual oil saturation, followed by more water. The well is shut-in, allowing the Ester Acetate to partially hydrolyze into Ethanol (secondary tracer). The well is then produced. The Ester Acetate concentration peak will be chromatographically retarded compared to that of Ethanol, because Ester Acetate partitions into the immobile oil more than Ethanol does. This separation is a function of residual oil saturation. The tracers simulated herein are Normal Propyl Alcohol (NPA), Ethyl Acetate (EtAc), Ethyl Alcohol (EtOH), and Isopropyl Alcohol (IPA). The properties and simulation input data for the tracers are listed in Table 13. Normal Propyl Alcohol (NPA) is the cover tracer, which is used to confirm the shape and position of the reactive tracer production histories in cases of excessive hydrolysis and drift. Ethyl Acetate (EtAc) is the reactive/partitioning tracer, which is the main tracer for residual oil saturation measurements. Ethyl Alcohol (EtOH) is the product tracer, which results from the hydrolysis of the reactive tracer. Isopropyl Alcohol (IPA) is the material balance tracer, which is a non-partitioning, non-reacting tracer that is included with all injected fluid to check material balance and to help determine if there is regional fluid drift in the reservoir.

TABLE 13
Tracer Properties and simulation data

| | | Molecular | | | Kinetic Rate | Injected |
|---|---|---|---|---|---|---|
| | | Weight | Density | Partition | Coefficient | Concentrations |
| Tracer | Name | (g/mole) | (g/cc) | Coefficient | (Days⁻¹) | (ppm) |
| Cover | Normal | 60.10 | 0.803 | — | — | 5000 |
| | Propyl | | | | | |
| | Alcohol | | | | | |
| | (NPA) | | | | | |
| Reactive | Ethyl | 74.08 | 0.917 | 2 | 0.1454 | 10000 |
| | Acetate | | | | | |
| | (EtAC) | | | | | |
| Product | Ethyl | 46.07 | 0.789 | — | — | — |
| | Alcohol | | | | | |
| | (EtOH) | | | | | |
| Material | Isopropyl | 61.10 | 0.785 | — | — | 2000 |
| Balance | Alcohol | | | | | |
| | (IPA) | | | | | |

The plan used for the low salinity water injection single-well chemical tracer test (LSWI SWCTT) is presented in Table 14, which includes a description of each step with the injection period. The LSWI SWCTT was designed for 31 days, based on real field applications. The reservoir's initial residual oil saturation to water (S_{orw}) ratio was set to be 0.37. This designed test has two main stages. In the first stage, seawater is injected for 1.35 days, followed by injection of the three tracers (NPA, EtAc, and IPA) for 0.14 days. After that, the IPA tracer is injected for 0.55 days to push the first slug of tracers away from the wellbore and allow the segregation of the reactive tracer (EtAc) between the static oil phase and the water phase for the designed depth of investigation. Next, the well is shut-in for 4 days to allow the hydrolysis of EtAc to EtOH. Subsequently, the well is produced for 8.96 days, where concentrations of all the tracers can be measured.

In the second phase, Low Salinity water is injected for 4 days, followed by seawater injection for 1.35 days. The seawater is injected to restore the initial salinity condition, which is compatible with the injected tracers. Similar to the first phase, Steps 2, 3, and 4 of the first tracer test are repeated, which includes injection of three tracers (NPA, EtAc, and IPA), additional injection of the IPA tracer, and shut-in of the well. Finally, the well is produced for 5.96 days, which allows measurement of the concentrations of the different tracers. FIG. 32 shows the injection and production histories of the designed plan, which highlights the injection, production, and shut-in periods.

TABLE 14
LSWI SWCTT Plan

| Stage | Step | Description | Duration (days) |
|---|---|---|---|
| 1 | 1 | Seawater Injection | 1.35 |
| | 2 | Three Tracers Injection | 0.14 |
| | | (NPA, EtAc, and IPA) | |
| | 3 | IPA Tracer Injection | 0.55 |
| | 4 | Well Shut-in | 4 |
| | 5 | Well Production | 8.96 |
| 2 | 6 | LSWI | 4 |
| | 7 | Seawater Injection | 1.35 |
| | | (Restore Initial Salinity Conditions) | |
| | 8 | Three Tracers Injection | 0.14 |
| | | (NPA, EtAc, and IPA) | |
| | 9 | IPA Tracer Injection | 0.55 |
| | 10 | Well Shut-in | 4 |
| | 11 | Well Production | 5.96 |

| | |
|---|---|
| Total Duration (Days) | 31 |

Herein, two approaches were used for analyzing the produced tracer concentration histories: analytical and numerical. Estimation of the change in oil saturation becomes possible after obtaining the concentrations of the different tracers used in the first and second phases of the designed LSWI SWCTT model. If ideal conditions are assumed, including a homogeneous reservoir and negligible injection and production times, the residual oil saturation may be directly calculated from the produced tracer concentration histories. The analytical approach utilizes the ester and alcohol peak locations to directly calculate residual oil saturation as the following (U.S. Pat. No. 3,623,842; Deans H A and Majoros S. The Single-Well Chemical Tracer Method for Measuring Residual Oil Saturation. US. DOE Report BC 20006-18, 1980; Deans H A and Carlisle C T. SPE 14886, 1986, Fifth Symposium on EOR, Tulsa, Okla., USA):

$${S}_{2 r} = \frac{{V}_{A} / {V}_{B - 1}}{{K}_{1 , 2}^{A} + {V}_{A} / {V}_{B} - 1} \qquad ( 28 )$$

where the brine and oleic phases are donated by 1 and 2, respectively, V_{A} is location of the ester peak, V_{B} is the location of the product alcohol (EtOH) peak, and K_{1,2}^{A} is the partition coefficient (i.e. tracer in oil/tracer conc. in brine) of the ester. The term (V_{A}/V_{B}−1) is the separation coefficient (β), which is determined by calculating the difference in the position of the product and reactive tracer peaks. This equation assumes a pulse injection of ester, absence of dispersion, and negligible shut-in and production times. This method requires peaks of tracers to be normally distributed (symmetrical about the y-axis).

Oil reservoirs in nature give a non-ideal behavior of tracer profiles. Hence, histories must be matched by numerical simulation to estimate residual oil saturation. Deans and Carlisle presented a numerical approach by which residual oil saturation is quantified by varying the saturation in theoretical computation in order to obtain the best fit the backflow tracer histories (Deans H A and Carlisle C T. The Single-Well Chemical Tracer Test—A Method For Measuring Reservoir Fluid Saturations In Situ. SPE Petroleum Engineering Handbook, Reservoir Engineering and Petrophysics, 2007, Volume V, pp 615-649). The tuning model parameters for history matching are basically dispersion coefficient, degree of heterogeneity, and residual oil saturation.

Herein, a numerical approach was used to calculate average residual oil saturation in the investigated zone using the SWCTT. The area in which oil saturation is below the original residual oil saturation was considered to be affected by the LSWI effect. If an area is not flooded by the low salinity water, its oil saturation will not decrease. Therefore, any gridblock i with an oil saturation smaller than the original residual oil saturation is used to calculate the average residual oil saturation. The equation used to calculate the average residual S̅ₒᵣ oil saturation is

$${\overline{S}}_{or} = \frac{{\sum }_{i} {S}_{o , i} {V}_{i}}{{\sum }_{i} {V}_{i}} ∀ i \text{:} {S}_{o , i} < 0.99 {S}_{or}^{HS} \qquad ( 29 )$$

where Sₒᵣ^{HS} is the original residual oil saturation corresponding to high salinity, Vᵢ is the pore volume of gridblock i.

The results of low salinity water injection SWCTT for three simulation cases: homogeneous radial model, heterogeneous radial model, and heterogeneous Cartesian model, are discussed below.

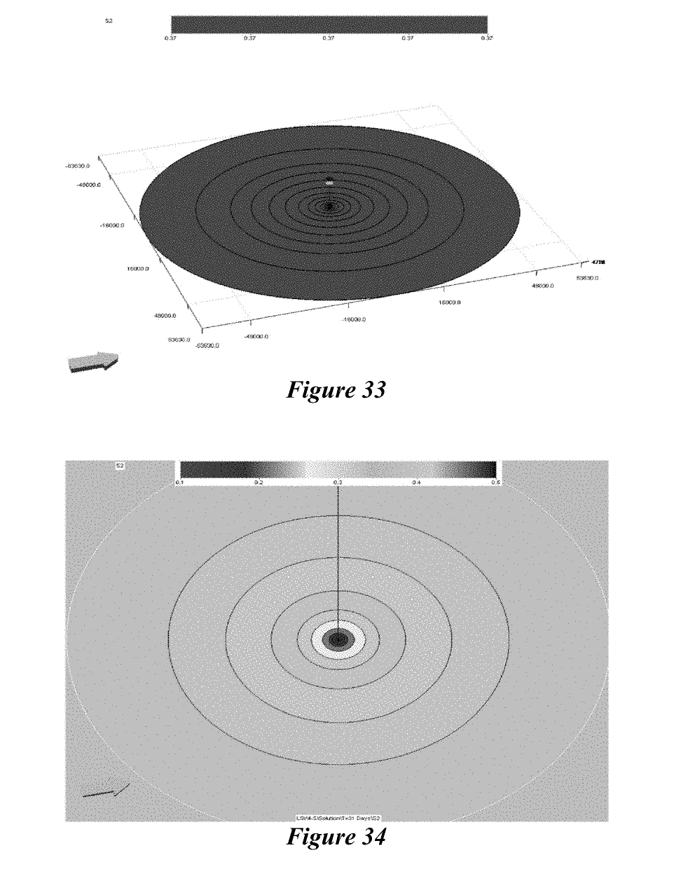

The homogeneous permeability radial model was used to simulate a low salinity SWCTT where the two-stage plan in Table 14 was followed. The simulated models were assumed to be initially at a residual oil saturation to water ratio of 0.37, as previously discussed. The initial residual oil saturation map at 0 days for this model is shown in FIG. 33, where it can be seen that the residual oil saturation is uniform in the investigated zone. FIG. 34 depicts the residual oil saturation map after 31 days and at the end of the LSWI SWCTT. FIG. 34 also shows a zoomed in map view at grid number 16 to visualize clearly the changes in residual oil saturation nearby the wellbore. A decrease in residual oil saturation was observed near the wellbore to about 0.1 as a result of injecting twice diluted seawater (pink color); however, a slight increase in oil saturation (light blue color) away from the wellbore was also observed, which reaches a higher value than the initial waterflood residual oil saturation of 0.37. This increase in residual oil saturation can be due to oil bank formation as a result of injecting the low salinity water and mobilizing the trapped oil saturation.

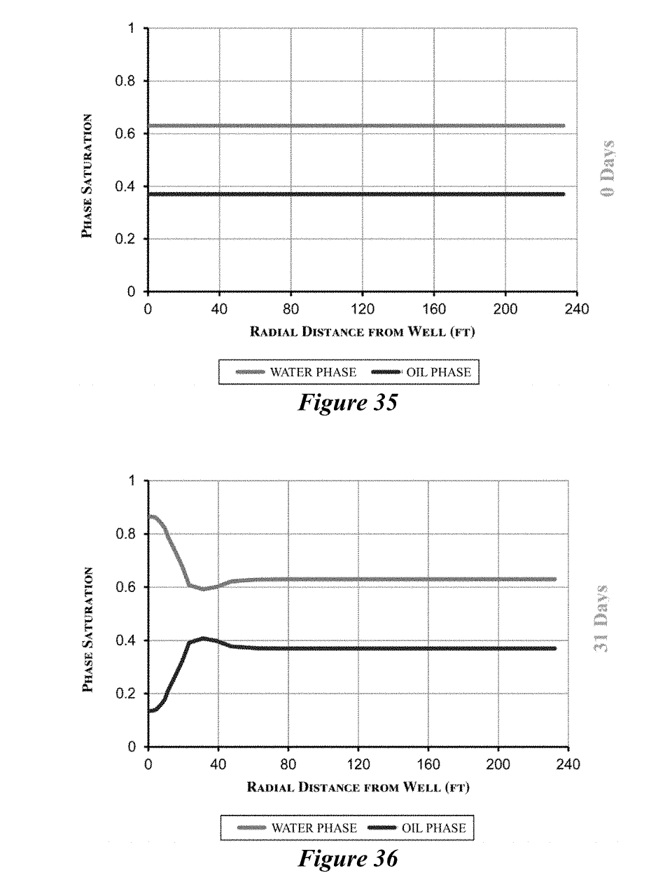

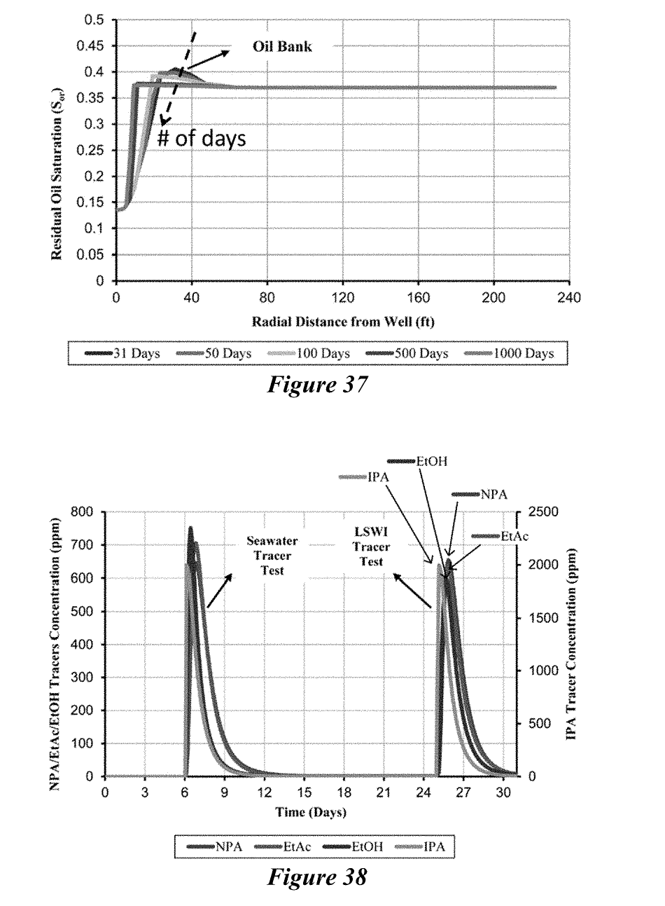

The oil bank formation was confirmed by plotting saturation profiles for water and oil phases at both the beginning and the end of the SWCTT, which correspond to 0 and 31 days as shown in FIG. 35 and FIG. 36, respectively. FIG. 35 depicts a uniform residual oil saturation of 0.37 at 0 days for the model up to the radius of investigation of 232 ft. The slight increase in residual oil saturation above the initially assigned value of 0.37 seen in FIG. 36 indicates oil bank formation. FIG. 37 depicts the residual oil saturation profile at different times where the designed SWCTT plan was modified by increasing the production time for the LSWI stage up to 50, 100, 500, and 1000 days. FIG. 37 shows that the oil bank disappears as the production period increases.

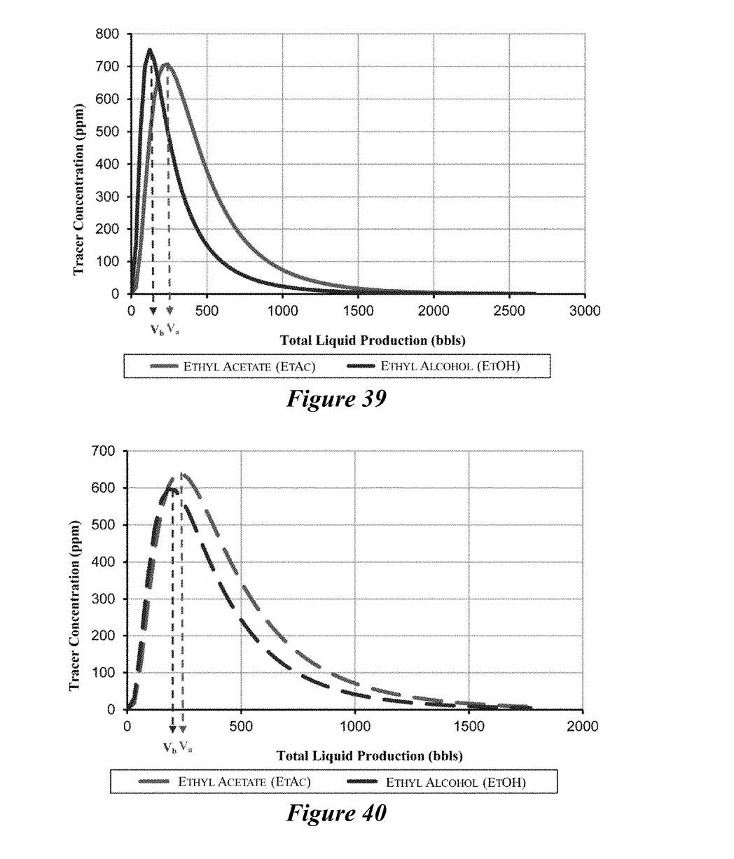

FIG. 38 shows the concentration histories of the NPA, EtAc, EtOH, and IPA tracers. The concentrations of the NPA, EtAc, and IPA tracers in FIG. 38 are different from those injected as previously reported in Table 13. This difference can be due to the different injection and production periods of the tracers as well as dispersion effects. On the other hand, the concentration of the EtOH tracer (product tracer) is affected by the injected concentration of the EtAc tracer (reactive tracer), the partition coefficient, and the reaction constant. The average residual oil saturation was determined using both the analytical and numerical methods for the first and second tracer tests. FIG. 39 and FIG. 40 show the concentration of the EtAc and EtOH tracers, in ppm, versus the total liquid production, in barrels, for the first and second tracer tests, respectively. Both FIG. 39 and FIG. 40 were used to determine the location of EtAc and EtOH peak concentrations donated by Vₐ and V_{b}, respectively.

The peak tracer concentrations along with the partition coefficient (K) were used in Equation (24) to determine the average residual oil saturation using the analytical method. Moreover, the residual oil saturation was also determined numerically using the empirical LSWI model. In both the homogeneous and heterogeneous radial models, the proposed numerical approach was not used due to the 1D and homogenous/minor heterogeneous nature of the models. Table 15 shows a comparison between the analytical and numerical approaches for the two stages using the homogeneous radial model. The comparison shows that both the analytical and numerical approaches were consistent in estimating the average residual oil saturation for the seawater tracer test (first step) and the LSWI tracer test (second step) with an error difference of ˜0.02. This consistency highlights the capability of the UTCHEM simulator to perform a LSWI SWCTT.

TABLE 15
Comparison of analytical and numerical approaches
(Homogeneous Radial Model - Two Stages)

| | | | | | | | Absolute |
|---|---|---|---|---|---|---|---|
| | | | | | Sₒᵣ | | Error |
| Stage | V_{A} | V_{B} | β | κ | Analytical | Numerical | Difference |
| Seawater | 250 bbl | 120 bbl | 1.083 | 2 | 0.351 | 0.370 | 0.019 |
| | (39.7 m³) | (19.1 m³) | | | | | |
| LSWI | 250 bbl | 183 bbl | 0.366 | 2 | 0.155 | 0.135 | 0.020 |
| | (39.7 m³) | (29.1 m³) | | | | | |

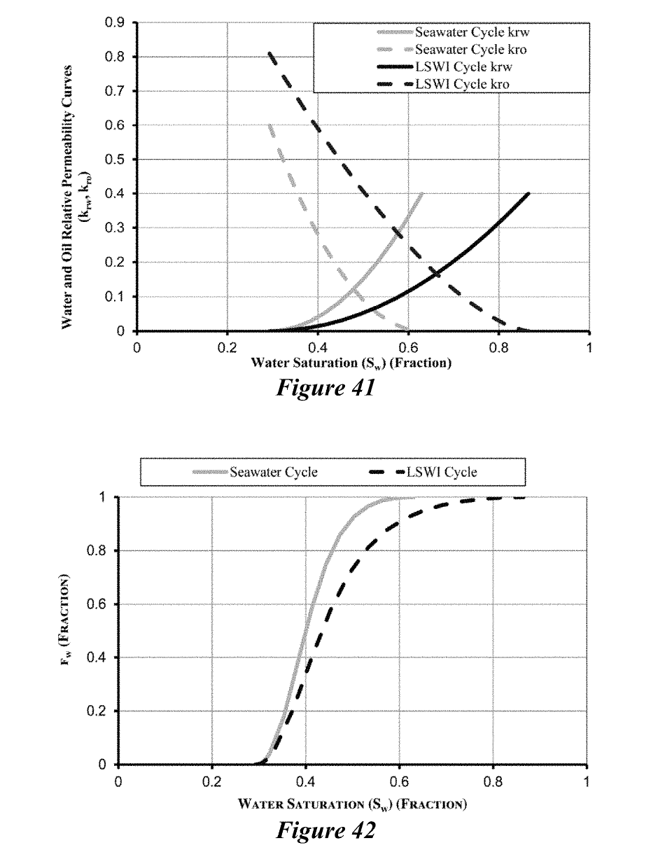

In addition, Table 15 shows a change in the location of EtOH peak concentration from 120 bbls during the first tracer test (e.g., seawater stage) to 183 bbls in the second test (e.g., LSWI stage). This change is related to the reduction in the residual oil saturation, which shortens the delay between both the EtAc location and the EtOH peak concentration of 250 bbls. Theoretically, the location of the EtAc and EtOH peak concentrations should be the same when the oil saturation is zero. The analysis shows that the location of the EtOH peak concentration (V_{B}) is mostly affected by the residual oil saturation. The relative permeability parameters used in the analysis are listed in Table 16 for the seawater and LSWI cycles. The relative permeability and fractional flow curves for both cycles are depicted in FIG. 41 and FIG. 42, respectively. Table 16, FIG. 41, and FIG. 42 show a decrease in both residual oil saturation and oil Corey's exponent and an increase in the oil relative permeability endpoint, whereas the water relative permeability parameters remain unchanged.

TABLE 16
Relative permeability curves for seawater and LSWI cycles
(Homogeneous Radial model)

| Parameter | Seawater Cycle | LSWI Cycle |
|---|---|---|
| k_{rw}* | 0.4 | 0.4 |
| kᵣₒ* | 0.6 | 0.809 |
| n_{w} | 2.0 | 2.0 |
| nₒ | 2.0 | 1.531 |
| S_{wirr} | 0.293 | 0.293 |
| S_{orw} | 0.37 | 0.135 |

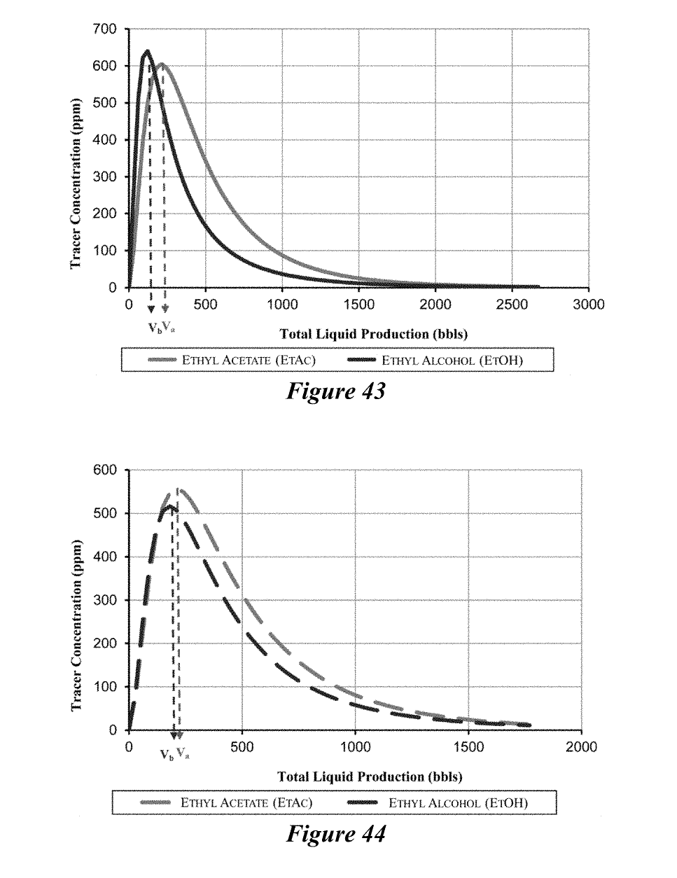

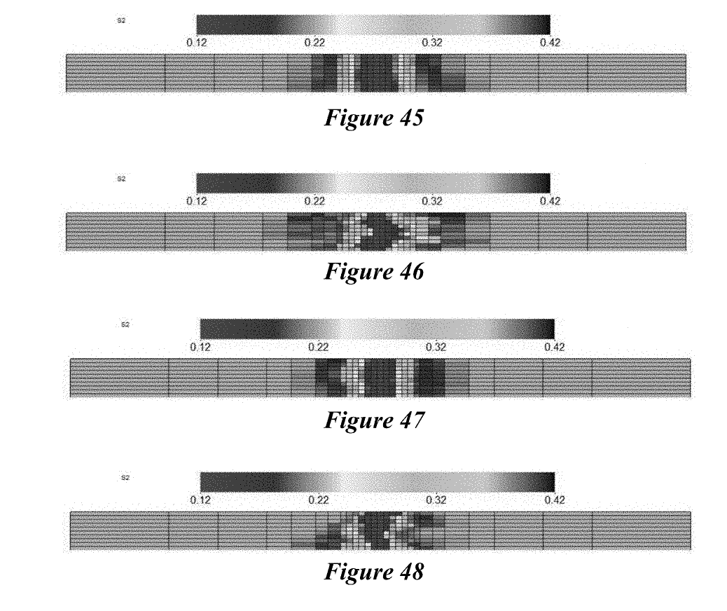

A heterogeneous radial model was also used to simulate the LSWI-SWCTT. A slight heterogeneity was introduced to the 1D radial model by assigning different porosity and permeability values to each gridblock, as was previously shown in FIG. 28 and FIG. 29 for porosity and permeability maps, respectively. For this case, the concentrations of EtAc and EtOH tracers versus the total liquid production are depicted in FIG. 43 and FIG. 44 for the first and second tracer tests, respectively. FIG. 43 and FIG. 44 show slightly asymmetric concentration profiles for the two tracers compared to the homogeneous radial model case (FIG. 39 and FIG. 40).

Average residual oil saturations were estimated again using both the analytical and numerical methods. The results of comparing both the analytical and numerical approaches in estimating residual oil saturation for the two stages using the heterogeneous radial model are listed in Table 17. The results shown in Table 17 show an inconsistency in the estimated residual oil saturation between the numerical and analytical approaches, where the absolute error difference in the estimated residual oil saturation is much greater than 0.02 (e.g., the absolute error is above the acceptable error threshold). The numerical analysis was conducted based on the empirical LSWI model. In addition, the location of the EtAc peak concentration is the same for both the first and second tracer tests, in this case 210 ppm (Table 17), which is consistent with the homogeneous radial model results. From this case, several points can be highlighted: The location of the EtAc peak concentration (V_{A}) is mostly affected by degree of heterogeneity. Once a slight heterogeneity is introduced into the model, the analytical method may not apply. The 1D and 2D radial model implemented in UTCHEM cannot capture complicated and severe heterogeneity levels of reservoirs. The numerical value of the average oil saturation works well despite heterogeneous permeability and porosity distribution of the reservoir model.

TABLE 17
Comparison of analytical and numerical approaches
(Heterogeneous Radial Model- Two Stages)

| | | | | | | | Absolute |
|---|---|---|---|---|---|---|---|
| | | | | | Sₒᵣ | | Error |
| Stage | V_{A} | V_{B} | β | κ | Analytical | Numerical | Difference |
| Seawater | 210 bbl | 120 bbl | 0.750 | 2 | 0.273 | 0.370 | 0.097 |
| | (33.4 m³) | (19.1 m³) | | | | | |
| LSWI | 210 bbl | 180 bbl | 0.167 | 2 | 0.077 | 0.135 | 0.058 |
| | (33.4 m³) | (28.6 m³) | | | | | |

Two heterogeneous Cartesian examples with Dykstra Parson Coefficients (V_{DP}) of 0.4 and 0.8 were used to simulate LSWI-SWCTT. The Cartesian model was used because it can capture complex and severe heterogeneity with anisotropy compared to the radial model implementation in UTCHEM. The permeability maps for the two heterogeneous Cartesian examples for a V_{DP} of 0.4 and a V_{DP} of 0.8 are shown in FIG. 30 and FIG. 31, respectively. The proposed two-step test (Table 14) was followed where the two examples had an initial residual oil saturation at the high salinity waterflood of 0.37.

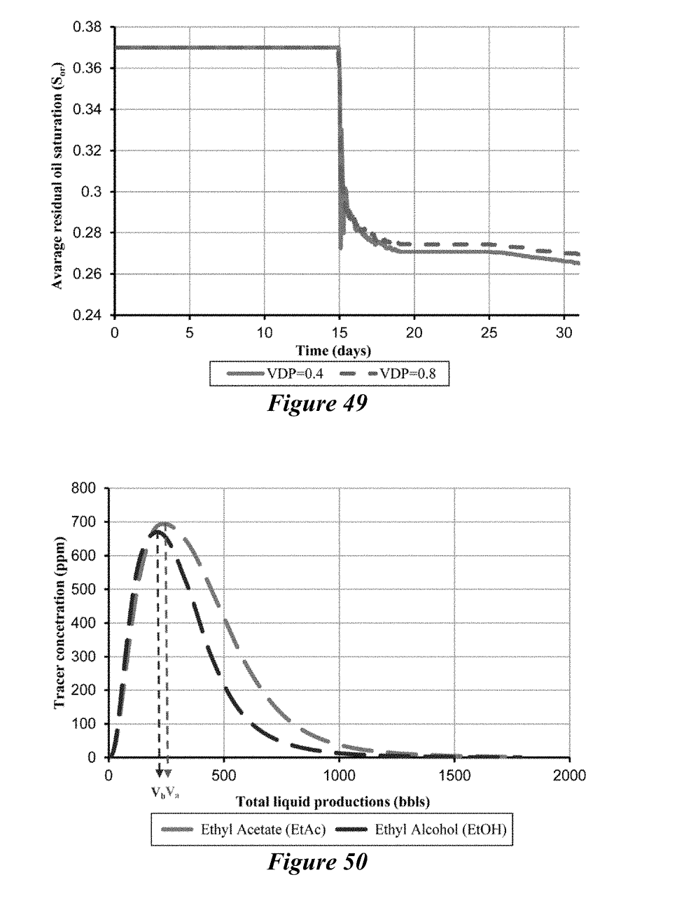

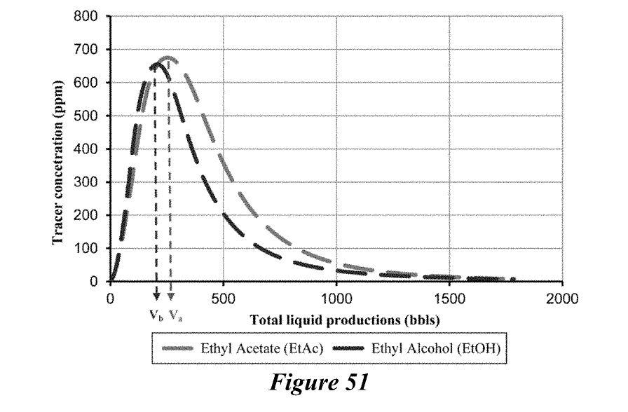

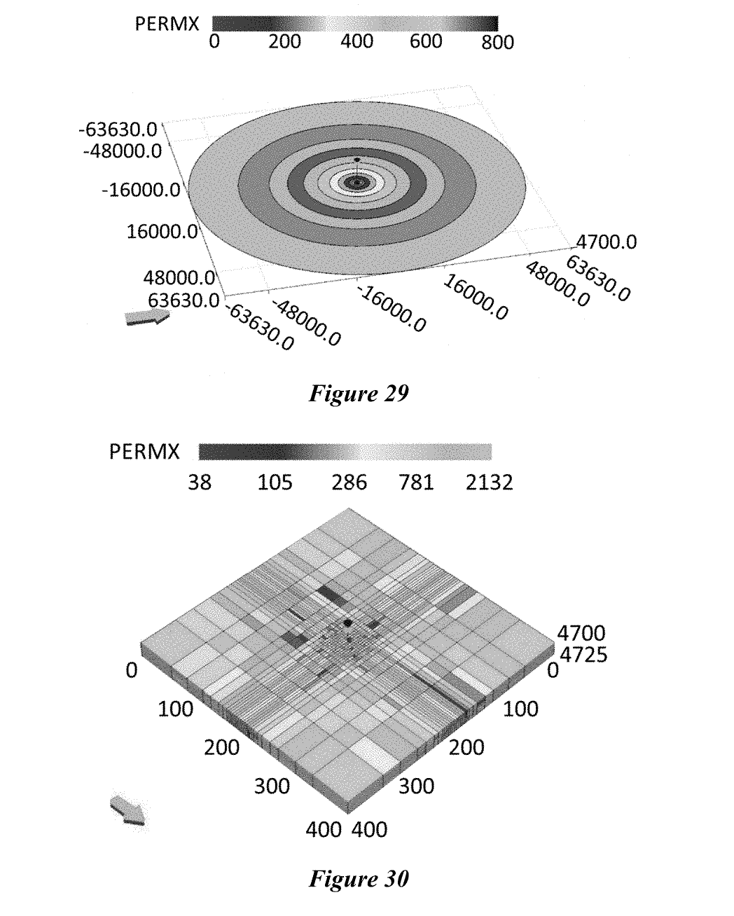

FIG. 45 shows the x-z plane oil saturation map across the center of the reservoir at the end of the test (31 days) for V_{DP}=0.4. FIG. 46 shows the x-z plane oil saturation map across the center of the reservoir at the end of the test (31 days) for V_{DP}=0.8. FIG. 47 shows the y-z plane oil saturation map across the center of the reservoir at the end of the test (31 days) for V_{DP}=0.4. FIG. 48 shows the y-z plane oil saturation map across the center of the reservoir at the end of the test (31 days) for V_{DP}=0.8. FIG. 45 to FIG. 48 show the formation of an oil bank as a result of low salinity water injection, which is in accordance with the radial model. Moreover, the spreading of the LSWI wave can be seen in FIG. 45 to FIG. 48 where the increase in heterogeneity level increases the tortuosity of the oil displacement. The average residual oil saturation with time calculated using the proposed numerical approach (Equation 25) is given in FIG. 49 for both cases (V_{DP}=0.4 and V_{DP}=0.8). FIG. 49 shows that the average residual oil saturation decreases quickly during the LSWI (days 15-19), and decreases only slightly during the second tracer test (days>19). The average residual oil saturation with moderate heterogeneity (V_{DP}=0.4) is smaller than that of strong heterogeneity (V_{DP}=0.8) due to less tortuosity of fluid flow path in the reservoir. At 31 days, the average residual oil saturations are 0.263 and 0.27 for both cases (V_{DP}=0.4 and V_{DP}=0.8), respectively. The tracer concentration profiles are shown in FIG. 50 and FIG. 51 for both cases (V_{DP}=0.4 and V_{DP}=0.8). The residual oil saturation was calculated using the conventional analytical method (Table 18). The residual oil saturation from the numerical method is significantly different from the analytical approach, which is consistent with the findings in the radial model (Table 18). Therefore, the tracer concentration profile from the heterogeneous reservoir could not be directly used to calculate the residual oil saturation using the analytical model.

TABLE 18
Comparison of analytical and numerical approaches
(Heterogeneous Cartesian Model- LSWI Stage)

| | | | | | | | Absolute |
|---|---|---|---|---|---|---|---|
| | | | | | Sₒᵣ | | Error |
| Case | V_{A} | V_{B} | β | κ | Analytical | Numerical | Difference |
| V_{DP} = 0.4 | 243 bbl | 212 bbl | 0.146 | 2 | 0.068 | 0.264 | 0.196 |
| | (38.6 m³) | (33.7 m³) | | | | | |
| V_{DP} = 0.8 | 250 bbl | 210 bbl | 0.190 | 2 | 0.087 | 0.270 | 0.183 |
| | (39.7 m³) | (33.4 m³) | | | | | |

The low salinity water injection single well chemical tracer test (LSWI-SWCTT) was simulated successfully using UTCHEM simulator with an empirical low salinity wettability alteration model (LSWI). A realistic two-step LSWI-SWCTT field plan was followed for three synthetic simulation models: homogeneous radial, heterogeneous radial, and heterogeneous Cartesian. The radial model in UTCHEM is limited as it does not capture heterogeneity and anisotropic permeability. The analytical model for estimating average residual oil saturation from peak tracer concentrations is only applicable to homogeneous reservoirs with symmetric effluent tracer concentration. A numerical approach was proposed in this work to estimate residual oil saturation for complex heterogeneous reservoirs with asymmetric tracer concentrations.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

What is claimed is:

1. A method of determining a property of a subsurface formation, the method comprising:
calculating a Gibbs free energy of the subsurface formation using a parameter of the subsurface formation; and
determining the property of the subsurface formation using the Gibbs free energy of the subsurface formation.

2. The method of claim 1, wherein the method further comprises collecting the parameter of the subsurface formation.

3. The method of claim 1, wherein the parameter of the subsurface formation includes temperature, pressure, porosity, pore volume, dimension, bulk volume, cross sectional area, permeability, rock type, or combinations thereof.

4. The method of claim 1, wherein the subsurface formation comprises a carbonate formation or a sandstone formation.

5. The method of claim 1, wherein the parameter is obtained at in situ conditions of the subsurface formation.

6. The method of claim 1, wherein the parameter includes the mole fraction of an aqueous species in an aqueous solution injected into the subsurface formation; a chemical potential of an aqueous species in an aqueous solution injected into the subsurface formation; the salinity of an aqueous solution injected into the subsurface formation; the volume of an aqueous solution injected into the subsurface formation; the ionic strength of an aqueous solution injected into the subsurface formation; an activity coefficient of an aqueous species in an aqueous solution injected into the subsurface formation; the concentration of an aqueous species in an aqueous solution injected into the subsurface formation; the water activity of an aqueous solution injected into the subsurface formation; or combinations thereof.

7. The method of claim 6, wherein the parameter includes the ionic strength of an aqueous solution injected into the subsurface formation, and wherein the method further comprises calculating the activity coefficient of an aqueous species in the aqueous solution injected into the subsurface formation using the ionic strength of the aqueous solution injected into the subsurface formation.

8. The method of claim 7, wherein calculating the activity coefficient of an aqueous species in the aqueous solution injected into the subsurface formation comprises using the Davies equation, the extended Debye-Huckel equation, the WATEQ Debye-Huckel equation, the Setchenow equation, or combinations thereof.

9. The method of claim 6, wherein the parameter of the subsurface formation comprises the concentration of an aqueous species in an aqueous solution injected into the subsurface formation, and wherein the method further comprises calculating the water activity of the aqueous solution injected into the subsurface formation using the concentration of the aqueous species in the aqueous solution injected into the subsurface formation.

10. The method of claim 9, wherein calculating the water activity of the aqueous solution injected into the subsurface formation comprises using Raoult's law or an approximation or derivative thereof.

11. The method of claim 1, wherein the parameter of the subsurface formation includes the Corey water exponent, the relative water permeability, the water saturation, or combinations thereof.

12. The method of claim 1, wherein the property of the subsurface formation includes the oil recovery, relative oil permeability, residual oil saturation, wettability alteration, dissolution, fine migration, Corey oil exponent, or combinations thereof.

13. The method of claim 1, wherein the method comprises:
receiving, using a computing device, the parameter of a subsurface formation;
storing, using the computing device, the parameter of the subsurface formation;
calculating, using the computing device, the Gibbs free energy of the subsurface formation using the parameter of the subsurface formation; and
determining, using the computing device, a property of the subsurface formation using the Gibbs free energy.

14. The method of claim 1, wherein the parameter comprises a parameter of an enhanced oil recovery technique, such that the method comprises modeling the effect of the enhanced oil recovery technique on the subsurface formation.

15. The method of claim 14, further comprising selecting an enhanced oil recovery technique for the subsurface formation based on the calculated property of the subsurface formation.

16. The method of claim 15, wherein the enhanced oil recovery technique comprises low salinity water injection.

17. A method for maximizing the oil recovery from a subsurface formation, the method comprising:
selecting a first set of parameters for an enhanced oil recovery technique;
calculating a first oil recovery from the subsurface formation based on the first set of parameters using the method of claim 1;
selecting a second set of parameters for the enhanced oil recovery technique;
calculating a second oil recovery from the subsurface formation based on the second set of parameters using the method of claim 1;
comparing the first oil recovery to the second oil recovery to determine the larger oil recovery, thereby determining the set of parameters for the enhanced oil recovery technique that maximizes the oil recovery from the subsurface formation;
selecting the set of parameters for the enhanced oil recovery technique that maximizes the oil recovery for the subsurface formation; and
applying the enhanced oil recovery technique to the subsurface formation using the selected set of parameters; thereby maximizing the oil recovery from the subsurface formation.

18. The method of claim 17, wherein the enhanced oil recovery technique comprises low salinity water injection.

19. A computing device comprising a processor and a memory operably coupled to the processor, the memory having further computer-executable instructions stored thereon that, when executed by the processor, cause the processor to:
receive a parameter of a subsurface formation;
store the parameter of the subsurface formation;
calculate a Gibbs free energy of the subsurface formation using the parameter of the subsurface formation;
determine a property of the subsurface formation using the Gibbs free energy; and
output the Gibbs free energy of the subsurface formation, the property of the subsurface formation, or a combination thereof.

20. The computing device of claim 19, wherein the parameter comprises a parameter of an enhanced oil recovery technique.

21. The computing device of claim 20, wherein the enhanced oil recovery technique comprises low salinity water injection.
